(19) United States
(12) Patent Application Publication
(10) Pub. No.: US 2018/0267483 A1
(43) Pub. Date: Sep. 20, 2018

(54) Electronic Timepiece And Method For Controlling Electronic Timepiece

(71) Applicant: Seiko Epson Corporation, Tokyo (JP)

(72) Inventor: Norimitsu BABA, Shiojiri (JP)

(21) Appl. No.: 15/919,690

(22) Filed: Mar. 13, 2018

(30) Foreign Application Priority Data
Mar. 14, 2017 (JP) 2017-048891
Dec. 21, 2017 (JP) 2017-245502

(51) Int. Cl. G04G 5/00; G04C 9/00

(52) U.S. Cl. CPC G04G 5/00; G04G 5/002; G04C 9/00

(57) ABSTRACT

An electronic timepiece includes: an information display unit; a storage unit which stores a plurality of pieces of region information and a daylight savings time observation rule corresponding to the region information; a selection unit which selects one of the plurality of pieces of region information stored in the storage unit; a determination unit which determines whether it is a region where daylight savings time is observed or not, based on the daylight savings time observation rule corresponding to the region information selected by the selection unit; and a display control unit which causes the information display unit to display that it is the region where daylight savings time is observed, if it is determined as the region where daylight savings time is observed.

### BACKGROUND

### 1. Technical Field

The present invention relates to an electronic timepiece and a method for controlling an electronic timepiece.

### 2. Related Art

A known electronic timepiece stores information about the observation of daylight savings time in association with each region and shows daylight savings time, for example, when the crown is operated to select a region and daylight savings time is observed in the selected region (see, for example, JP-A-2016-133337).

With the analog electronic timepiece disclosed in JP-A-2016-133337, the user can select one of a DST (AUTO) mode display setting in which daylight savings time is automatically shown according to daylight savings time observation information corresponding to the selected region, a STD mode display setting in which daylight savings time is not shown regardless of the daylight savings time observation information, and a DST mode display setting in which in which time is shown, shifted by a preset shift time regardless of the daylight savings time observation information. A mode hand indicates the type of the selected mode.

Incidentally, the status of observation of daylight savings time may change. That is, daylight savings time may become observed in a region where daylight savings time has not been observed before. Also, daylight savings time may no longer be observed in a region where daylight savings time has previously been observed.

Therefore, for example, if the daylight savings time observation rules stored in the electronic timepiece are not the latest version, the electronic timepiece may not show daylight savings time for a region where daylight savings time is observed, or may show daylight savings time for a region where daylight savings time is not observed. The user may wish to check whether or not the selected region is stored as a region where daylight savings time is observed, in the daylight savings time observation rules stored in the electronic timepiece.

However, with the analog electronic timepiece disclosed in JP-A-2016-133337, when the DST (AUTO) mode display setting is selected, the mode hand indicates DST (AUTO) whether or not daylight savings time observation information is stored for the selected region. Therefore, the user cannot grasp whether or not the selected region is stored as a region where daylight savings time is observed.

### SUMMARY

An advantage of some aspects of the invention is to provide an electronic timepiece and a method for controlling an electronic timepiece that enable the user to grasp whether or not the selected region is stored as a region where daylight savings time is observed.

An electronic timepiece according to an aspect of the invention includes: an information display unit; a storage unit which stores a plurality of pieces of region information and a daylight savings time observation rule corresponding to the region information; a selection unit which selects one of the plurality of pieces of region information stored in the storage unit; a determination unit which determines whether it is a region where daylight savings time is observed or not, based on the daylight savings time observation rule corresponding to the region information selected by the selection unit; and a display control unit which causes the information display unit to display that it is the region where daylight savings time is observed, if it is determined as the region where daylight savings time is observed.

According to the aspect of the invention, the user can grasp whether or not the daylight savings time observation rule indicating that it is a region where daylight savings time is observed is stored for the selected region.

Therefore, if the electronic timepiece does not show that it is a region where daylight savings time is observed even when a region where daylight savings time is observed is selected, or if the electronic timepiece shows that it is a region where daylight savings time is observed even when a region where daylight savings time is not observed is selected, the user can understand that the daylight savings time observation rule stored in the storage unit for the selected region is not correct. Thus, if the electronic timepiece does not show that it is a region where daylight savings time is observed even when a region where daylight savings time is observed is selected, the user can take measures such as manually correcting the time during a daylight savings time observation period. Meanwhile, if the electronic timepiece shows that it is a region where daylight savings time is observed even when a region where daylight savings time is not observed is selected, the user can takes measures such as operating and setting the electronic timepiece not to show daylight savings time.

It is preferable that the electronic timepiece according to the aspect of the invention includes a satellite signal receiving unit which receives a satellite signal and calculates and acquires location information of a current location based on the received signal, and that the selection unit selects region information to which the current location belongs from the plurality of pieces of region information, based on the location information.

According to the aspect of the invention with this configuration, the user can select the region information of the current location, for example, by pressing a button on the electronic timepiece and thus causing the electronic timepiece to receive a satellite signal. Therefore, the user can select the location information of the current location more easily than in the case of operating a button or the crown of the electronic timepiece until the location information of the current location is selected.

It is preferable that the electronic timepiece according to the aspect of the invention includes a manual operation unit and that the selection unit selects one of the plurality of pieces of region information in response to an operation on the manual operation unit.

According to the aspect of the invention with this configuration, the user can also select the region information of a different region from the current location by operating the manual operation unit. Therefore, for example, when moving from Japan to a certain region abroad, the user can grasp in advance whether the daylight savings time observation rule indicating that the region is a region where daylight savings time is observed is stored in the electronic timepiece or not.

It is preferable that the electronic timepiece according to the aspect of the invention includes a radio wave receiving unit which receives radio waves including observation status information indicating whether daylight savings time is currently observed or not, and an observation determination unit which determines whether daylight savings time is currently observed or not, based on the observation status information, and that the display control unit causes the information display unit to display that daylight savings time is currently observed, if it is determined that daylight savings time is currently observed.

According to the aspect of the invention with this configuration, the user can grasp whether daylight savings time is currently observed or not.

Also, with this configuration, whether daylight savings time is currently observed or not can be determined based on the observation status information. Therefore, there is no need to determine whether the current time falls within a daylight savings time observation period or not. This makes it easy to determine whether daylight savings time is currently observed or not.

In the electronic timepiece according to the aspect of the invention, it is preferable that the daylight savings time observation rule includes observation period information indicating a daylight savings time observation period, that the electronic timepiece includes an observation determination unit which determines whether daylight savings time is currently observed or not, based on the observation period information corresponding to the region information selected by the selection unit, and that the display control unit causes the information display unit to display that daylight savings time is currently observed, if it is determined that daylight savings time is currently observed.

According to the aspect of the invention with this configuration, the user can grasp whether daylight savings time is currently observed or not.

Also, with this configuration, whether daylight savings time is currently observed or not can be determined based on the observation period information. Therefore, for example, there is no need for a radio wave receiving unit which receives radio waves including information indicating whether daylight savings time is currently observed or not.

It is preferable that the electronic timepiece according to the aspect of the invention includes: a time display unit which is controlled by the display control unit and displays time information; a time correction unit which corrects the time information; and an observation determination unit which determines whether daylight savings time is currently observed or not, that the daylight savings time observation rule includes daylight savings time setting information about a time difference between standard time and daylight savings time according to the region information, and that the time correction unit corrects the time information based on the daylight savings time setting information if it is determined that daylight savings time is currently observed.

According to the aspect of the invention with this configuration, when the daylight savings time observation period has started in the selected region, the electronic timepiece can display daylight savings time without the user having to carry out an operation to display daylight savings time. Also, when the daylight savings time observation period has ended, the electronic timepiece can display standard time without the user having to carry out an operation to display standard time.

It is preferable that the electronic timepiece according to the aspect of the invention includes a manual operation unit, and a mode setting unit which sets one of a daylight savings time automatic display mode and a daylight savings time non-display mode in response to an operation on the manual operation unit, that the time correction unit corrects the time information and causes daylight savings time to be displayed, based on the daylight savings time setting information, if the daylight savings time automatic display mode is set and the observation determination unit determines that daylight savings time is currently observed, and that the time correction unit does not cause daylight savings time to be displayed, if the daylight savings time automatic display mode is set and the observation determination unit determines that daylight savings time is not currently observed, or if the daylight savings time non-display mode is set.

According to the aspect of the invention with this configuration, if the electronic timepiece shows that it is a region where daylight savings time is observed even if a region where daylight savings time is not observed is selected, the user can set the electronic timepiece not to show daylight savings time, by operating the manual operation unit to set the daylight savings time non-display mode.

An electronic timepiece according to another aspect of the invention includes: an information display unit; a time display unit which displays time information; a time correction unit which corrects the time information; a display control unit; a manual operation unit; a storage unit which stores a plurality of pieces of region information and a daylight savings time observation rule, the daylight savings time observation rule including observation period information corresponding to the region information and indicating a daylight savings time observation period and daylight savings time setting information corresponding to the region information and indicating a time difference from standard time; a selection unit which selects one of the plurality of pieces of region information stored in the storage unit; a determination unit which determines whether it is a region where daylight savings time is observed or not, based on the daylight savings time observation rule corresponding to the region information selected by the selection unit; an observation determination unit which determines whether daylight savings time is currently observed or not, based on the observation period information; and a mode setting unit which sets one of a daylight savings time automatic display mode, a daylight savings time display mode, and a daylight savings time non-display mode in response to an operation on the manual operation unit. The display control unit causes the information display unit to display that it is the region where daylight savings time is observed, if the daylight savings time automatic display mode is set and the determination unit determines that it is the region where daylight savings time is observed. The time correction unit corrects the time information and causes daylight savings time to be displayed, based on the daylight savings time setting information, if the daylight savings time automatic display mode is set and it is determined that daylight savings time is currently observed, or if the daylight savings time display mode is set. The time correction unit does not cause daylight savings time to be displayed, if the daylight savings time automatic display mode is set and it is determined that daylight savings time is not currently observed, or if the daylight savings time non-display mode is set.

According to the aspect of the invention, if the daylight savings time automatic display mode is set, the user can grasp whether or not the daylight savings time observation rule indicating that it is a region where daylight savings time is observed is stored the electronic timepiece for the selected region.

Then, for example, if the electronic timepiece does not show that it is a region where daylight savings time is observed even when a region where daylight savings time is observed is selected, the user can cause daylight savings time to be displayed, by operating the manual operation unit to set the daylight savings time display mode during the daylight savings time observation period.

Meanwhile, if the electronic timepiece shows that it is a region where daylight savings time is observed even when a region where daylight savings time is not observed is selected, the user can stop daylight savings time from being displayed, by operating the manual operation unit to set the daylight savings time non-display mode.

Also, if the daylight savings time automatic display mode is set, when the daylight savings time observation period has started in the selected region, the electronic timepiece can display daylight savings time without the user having to carry out an operation to display daylight savings time. When the daylight savings time observation period has ended, the electronic timepiece can display standard time without the user having to carry out an operation to display standard time.

In the electronic timepiece according to the aspect of the invention, it is preferable that the display control unit causes the information display unit to display that the daylight savings time display mode is set if the daylight savings time display mode is set, and causes the information display unit to display that the daylight savings time non-display mode is set if the daylight savings time non-display mode is set.

According to the aspect of the invention with this configuration, the user can gasp that the daylight savings time display mode or the daylight savings time non-display mode is set, and therefore can easily select a display mode.

A electronic timepiece according to still another aspect of the invention includes: an information display unit; a time display unit which displays time information; a time correction unit which corrects the time information; a display control unit; a manual operation unit; a storage unit which stores a plurality of pieces of region information and a daylight savings time observation rule, the daylight savings time observation rule including observation period information corresponding to the region information and indicating a daylight savings time observation period and daylight savings time setting information corresponding to the region information and indicating a time difference from standard time; a selection unit which selects one of the plurality of pieces of region information stored in the storage unit; a determination unit which determines whether it is a region where daylight savings time is observed or not, based on the daylight savings time observation rule corresponding to the region information selected by the selection unit; an observation determination unit which determines whether daylight savings time is currently observed or not, based on the observation period information; and a mode setting unit which sets one of a daylight savings time display mode and a daylight savings time non-display mode in response to an operation on the manual operation unit. The display control unit causes the information display unit to display that the daylight savings time display mode is set if the daylight savings time display mode is set, and causes the information display unit to display that the daylight savings time non-display mode is set if the daylight savings time non-display mode is set. The time correction unit corrects the time information and causes daylight savings time to be displayed, based on the daylight savings time setting information corresponding to the region information selected by the selection unit, if the daylight savings time display mode is set. The time correction unit causes standard time to be displayed if the daylight savings time non-display mode is set.

According to the aspect of the invention, the user can set the daylight savings time display mode or the daylight savings time non-display mode by operating the manual operation unit. This enables the user to easily set the display or non-display of daylight savings time. Therefore, even in a region where the daylight savings time observation rule is changed, the time conforming to the changed rule (standard or daylight savings time in the region) can be displayed by manual operation. This can improve convenience.

It is preferable that the electronic timepiece according to the aspect of the invention includes a satellite signal receiving unit which receives a satellite signal and calculates and acquires location information of a current location based on the received signal, that the selection unit selects region information to which the current location belongs from the plurality of pieces of region information, based on the location information, that the mode setting unit sets a daylight savings time automatic display mode if the determination unit determines that it is a region where daylight savings time is observed, based on the region information selected based on the location information, and sets the daylight savings time non-display mode if the determination unit determines that it is a region where daylight savings time is not observed, based on the region information selected based on the location information, that the display control unit causes the information display unit to display that it is the region where daylight savings time is observed, if the daylight savings time automatic display mode is set and the determination unit determines that it is the region where daylight savings time is observed, that the time correction unit corrects the time information and causes daylight savings time to be displayed, based on the daylight savings time setting information, if the daylight savings time automatic display mode is set and it is determined that daylight savings time is currently observed, and that the time correction unit causes standard time to be displayed, if the daylight savings time automatic display mode is set and it is determined that daylight savings time is not currently observed.

According to the aspect of the invention with this configuration, positioning signal reception processing to acquire the location information of the current location is executed in addition to the selection of the daylight savings time display mode or the daylight savings time non-display mode by an operation on the manual operation unit. This enables automatic setting of the daylight savings time automatic display mode or the daylight savings time non-display mode. Therefore, the user can carry out the positioning signal reception processing at a travel destination or the like and thus can have the time automatically displayed which conforms to the daylight savings time observation rule for the region. Also, if the automatically displayed times is different from the time of the current location, such as immediately after the daylight savings time observation rule is changed, the user can easily change the displayed time to standard time or daylight savings time by operating the manual operation unit to select the daylight savings time display mode or the daylight savings time non-display mode.

In the electronic timepiece according to the aspect of the invention, it is preferable that the information display unit is configured of hands and a dial.

According to the aspect of the invention with this configuration, even an analog electronic timepiece can display whether or not it is a region where daylight savings time is observed.

A method for controlling an electronic timepiece according to still another aspect of the invention is a method for controlling an electronic timepiece including an information display unit and a storage unit which stores a plurality of pieces of region information and a daylight savings time observation rule corresponding to the region information. The method includes: selecting one of the plurality of pieces of region information stored in the storage unit; determining whether or not it is a region where daylight savings time is observed, based on the daylight savings time observation rule corresponding to the selected region information; and causing the information display unit to display that it is the region where daylight savings time is observed, if it is determined that it is the region where daylight savings time is observed.

According to the aspect of the invention, the user can grasp whether the daylight savings time observation rule indicating that the selected region is a region where daylight savings time is observed is stored in the electronic timepiece or not.

### BRIEF DESCRIPTION OF THE DRAWINGS

Embodiments of the invention will be described with reference to the accompanying drawings, wherein like numbers reference like elements.

FIG. 1 is a front view of an electronic timepiece according to a first embodiment of the invention.

FIG. 2 is a cross-sectional view schematically showing the electronic timepiece of the first embodiment.

FIG. 3 shows the circuit configuration of the electronic timepiece of the first embodiment.

FIG. 4 shows the data configuration of a RAM in the first embodiment.

FIG. 5 shows an example of local time setting data in the first embodiment.

FIG. 6 shows an example of daylight savings time reference data in the first embodiment.

FIG. 7 shows the configuration of a control circuit in the first embodiment.

FIG. 8 is a flowchart showing local time setting processing in the first embodiment.

FIG. 9 is a flowchart showing local time setting processing in the first embodiment.

FIG. 10 is a flowchart showing daylight savings time switching processing in the first embodiment.

FIG. 11 is a front view of an electronic timepiece according to a second embodiment of the invention.

FIG. 12 is a cross-sectional view schematically showing the electronic timepiece according to the second embodiment.

FIG. 13 shows the circuit configuration of the electronic timepiece according to the second embodiment.

FIG. 14 shows the data configuration of a storage device in the second embodiment.

FIG. 15 shows local time reception setting data in the second embodiment.

FIG. 16 explains local time reception setting data.

FIG. 17 shows the configuration of a control circuit in the second embodiment.

FIG. 18 is a flowchart showing local time reception setting processing in the second embodiment.

FIG. 19 is a flowchart showing local time reception setting processing in the second embodiment.

FIG. 20 shows a history of change in the status of observance of daylight savings time.

FIG. 21 shows the configuration of a control circuit in a third embodiment of the invention.

FIG. 22 is a flowchart showing display mode switching processing in the third embodiment.

FIG. 23 shows an example of daylight savings time reference data in a fourth embodiment of the invention.

FIG. 24 shows the display mechanism of an electronic timepiece according to the fourth embodiment.

FIG. 25 is a flowchart showing display mode switching processing in the fourth embodiment.

FIG. 26 is a front view of an electronic timepiece according to a fifth embodiment of the invention.

FIG. 27 shows the circuit configuration of the electronic timepiece according to the fifth embodiment.

FIG. 28 is a flowchart showing standard radio wave reception processing in the fifth embodiment.

FIG. 29 is a front view of an electronic timepiece according to a sixth embodiment of the invention.

FIG. 30 shows the configuration of a control circuit in the sixth embodiment.

FIG. 31 is a flowchart showing reception processing in the sixth embodiment.

FIG. 32 is a flowchart showing reception processing in the sixth embodiment.

FIG. 33 is a flowchart showing display mode switching processing in the sixth embodiment.

FIG. 34 shows the display mechanism of an electronic timepiece according to another embodiment.

FIG. 35 is a flowchart showing daylight savings time switching processing in another embodiment.

FIG. 36 shows the display mechanism of an electronic timepiece according to another embodiment.

FIG. 37 shows the display mechanism of an electronic timepiece according to another embodiment.

DESCRIPTION OF EXEMPLARY EMBODIMENTS

### First Embodiment

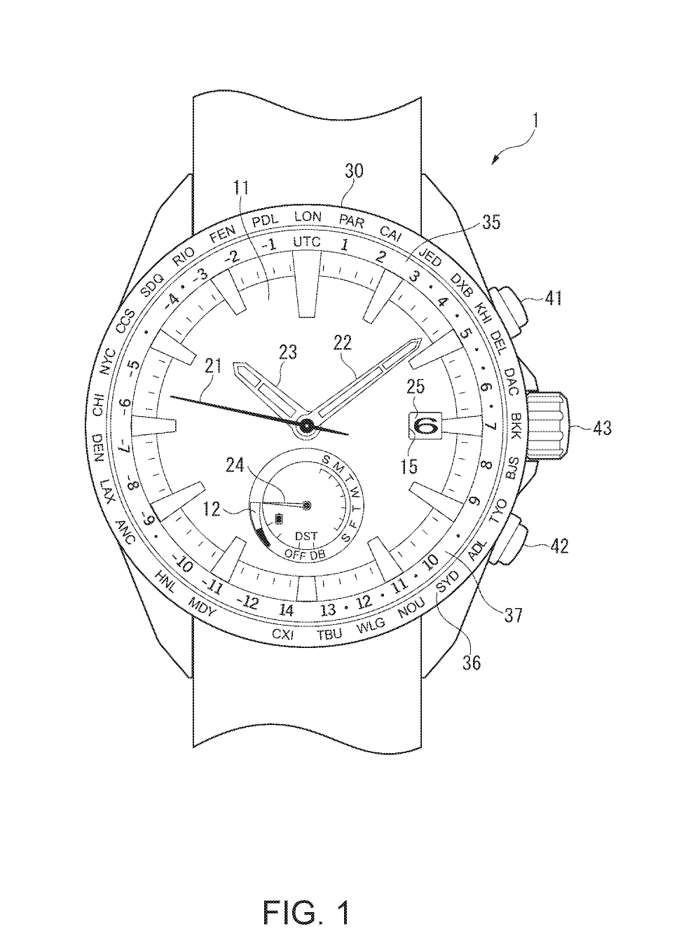

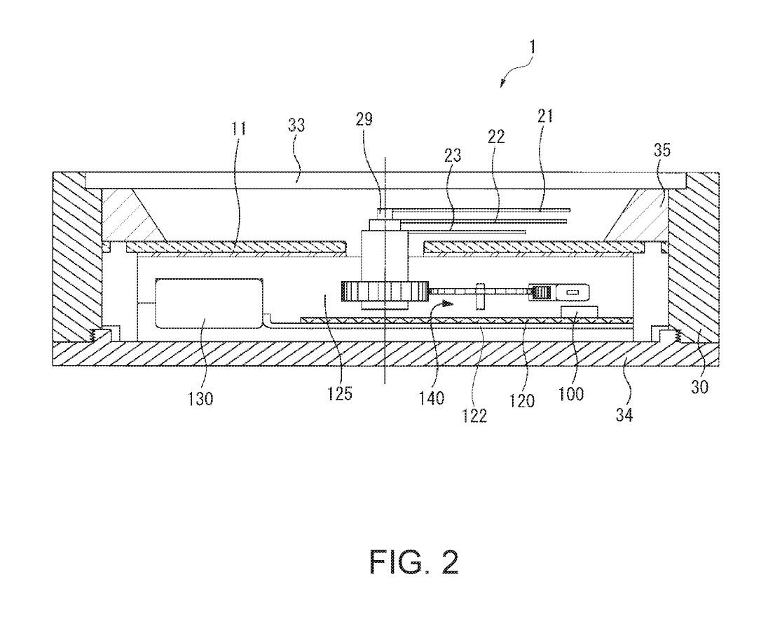

FIG. 1 is a front view of an electronic timepiece 1. FIG. 2 is a cross-sectional view schematically showing the electronic timepiece 1.

As shown in FIGS. 1 and 2, the electronic timepiece 1 includes an outer case 30, a glass cover 33, and a back cover 34.

The outer case 30 is cylindrical and formed of a metal. As shown in FIG. 2, of the two openings of the outer case 30, the opening on the face side is closed by the glass cover 33, and the opening on the back side is closed by the back cover 34 formed of a metal.

On a lateral side of the outer case 30, an A-button 41, a B-button 42, and a crown 43 are provided.

On the inner side of the outer case 30, a dial ring 35, a dial 11, hands 21, 22, 23, 24, a calendar wheel 25, a drive mechanism 140 which drives each hand and the calendar wheel 25 and the like are provided.

The dial ring 35 is formed in the shape of a ring.

The dial 11 is a circular plate member which displays time on the inner side of the outer case 30. The dial 11 has the respective hands 21 to 24 provided between itself and the glass cover 33. The dial 11 is arranged on the inner side of the dial ring 35.

In the dial 11, holes are formed through which a hand shaft 29 for the hands 21, 22, 23 and a hand shaft, not illustrated, for the hand 24, penetrate the dial 11. In the dial 11, an opening of a calendar window 15 is formed as well.

The drive mechanism 140 is installed on a bottom plate 125 and is covered with a circuit board 120 from the back cover side. The drive mechanism 140 has a step motor and a train wheel such as gears. The step motor rotates the hand shafts via the train wheel, thus driving the respective hands 21 to 24 and the calendar wheel 25.

Specifically, the drive mechanism 140 has first to fourth drive mechanisms. The first drive mechanism drives the hand 22 and the hand 23. The second drive mechanism drives the hand 21. The third drive mechanism drives the hand 24. The fourth drive mechanism drives the calendar wheel 25.

The circuit board 120 has a control device 100 on the face side. The back cover side of the circuit board 120 is provided with a circuit holder 122 for covering the circuit board 120. Also, a battery 130 is provided between the bottom plate 125 and the back cover 34.

### Display Mechanism of Electronic Timepiece

The hands 21, 22, 23 are installed on the hand shaft 29 provided along the face-back direction of the dial 11, at the plane center of the dial 11. The hand shaft 29 is configured of three hand shafts on which the hands 21, 22, 23 are installed respectively.

On the inner circumferential side of the dial ring 35 surrounding the outer circumferential part of the dial 11, marks dividing the inner circumference into 60 parts are given, as shown in FIG. 1. Using these marks, the hand 21 shows the “second” of the time, the hand 22 shows the “minute” of the time, and the hand 23 shows the “hour” of the time. That is, the hand 21 is the second hand, the hand 22 is the minute hand, and the hand 23 is the hour hand. The hands 21 to 23 and the dial 11 form a time display unit which displays time information. The time displayed by the hands 21 to 23 can be changed by pulling out the crown 43 to the second click and rotating the crown 43 in this state.

The hand 24 is installed on the hand shaft provided at a position in the direction of 6 o'clock from the planar center of the dial 11.

On the outer circumference of the rotation area of the hand 24, the alphabet letters “DB” and “OFF” are given. The “DB” and “OFF” are information about daylight savings time (summer time). On the inner side of the alphabet letters “DB” and “OFF”, the alphabet letters “DST” meaning daylight savings time are given.

As will be described in detail later, by pointing at DB, the hand 24 shows that, based on a daylight savings time observation rule corresponding to selected region information, the region is stored in a storage device 54 as a region where daylight savings time is observed. Meanwhile, by pointing at OFF, the hand 24 shows that, based on the daylight savings time observation rule, the region is not stored in the storage device 54 as a region where daylight savings time is observed (or the region is stored in the storage device 54 as a region where daylight savings time is not observed).

On the outer circumference of the rotation area of the hand 24, the letters “S (Sunday)”, “M (Monday)”, “T (Tuesday)”, “W (Wednesday)”, “T (Thursday)”, “F (Friday)”, and “S (Saturday)” are given, which are the initials of English words expressing the seven days of the week. The hand 24 points at one of these letters and thus shows the day of the week.

On the outer circumference of the rotation area of the hand 24, a crescent sickle-shaped symbol 12 is given along the circumference. This symbol 12 is the power indicator of the battery 130. The hand 24 points at a position corresponding to the battery capacity, thus showing the battery capacity.

That is, the hand 24 is a mode hand showing various kinds of information. The hand 24 and the dial 11 form an information display unit.

In a normal state where the crown 43 is located at a 0-position, the hand 24 shows one of information about daylight savings time (DB or OFF), the day of the week, and the battery capacity. The information shown by the hand 24 can be switched by pressing the B-button 42.

The calendar window 15 is provided in an opening which opens in a rectangular shape in the dial 11. A numeral printed on the calendar wheel 25 is visible through the opening. The calendar wheel 25 shows the “day” of the year, month and day by having the numeral visually recognized through the opening. The day shown by the calendar wheel 25 can be changed by pulling out the crown 43 to the second click and rotating the crown 43 in this state. Whether to change the day or to change the time shown by the hands 21 to 23 can be selected by pressing the A-button 41.

On the dial ring 35, symbols 37 including numerals that express time differences from Coordinated Universal Time (UTC) and non-numeral symbols are given along the marks on the inner circumferential sides.

On the outer case 30 provided around the dial ring 35, city information 36 indicating the names of representative cities using standard time corresponding to the numerals and non-numeral symbols 37 given on the dial ring 35 is provided along with the symbols 37.

The hand 21 points at a symbol 37 and the corresponding city information 36, thus showing the currently set time difference or the currently selected time difference.

### Circuit Configuration of Electronic Timepiece

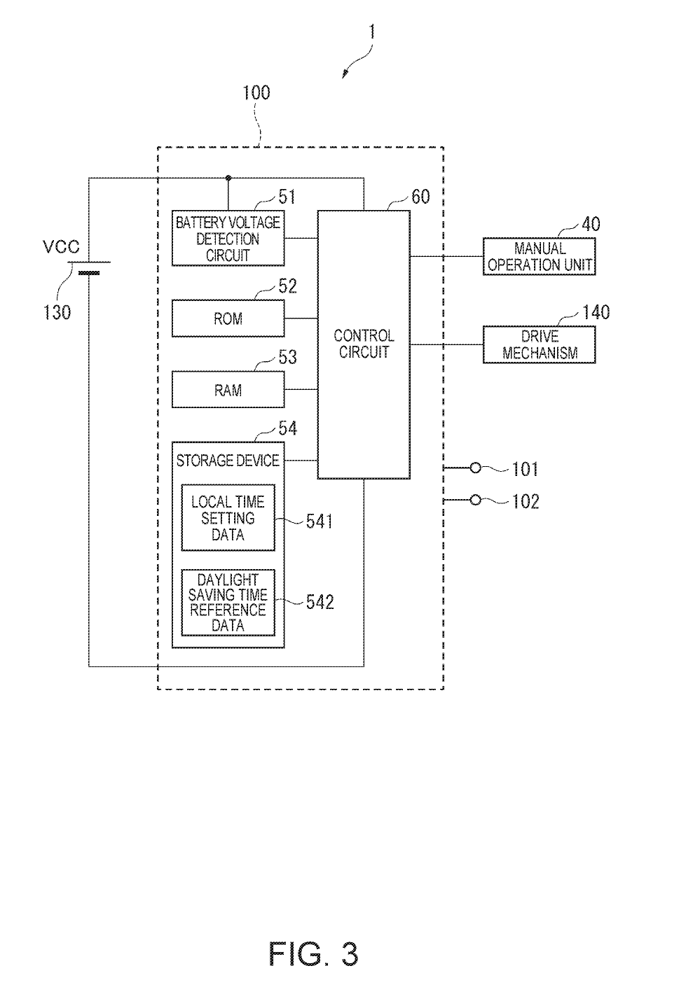

FIG. 3 shows the circuit configuration of the electronic timepiece 1.

The electronic timepiece 1 includes the control device 100 configured of a CPU (central processing unit), the battery 130 connected to the control device 100, a manual operation unit 40, and the drive mechanism 140.

The manual operation unit 40 includes the A-button 41, the B-button 42, the crown 43, and a switch circuit, not illustrated, and outputs operation signals corresponding to the press/release of each of the buttons 41, 42 and the pull, push and rotation of the crown 43 to a control circuit 60, described later, of the control device 100.

The control device 100 includes a battery voltage detection circuit 51, a ROM (read only memory) 52, a RAM (random access memory) 53, a rewritable storage device 54, and a control circuit 60.

The control device 100 is connected to two input terminals 101, 102 provided on the back cover side of the circuit board 120. When the back cover 34 of the electronic timepiece 1 is opened, an output terminal of an external device can be brought into contact with the input terminals 101, 102. Data can be supplied from the output terminal to the input terminals 101, 102, thus rewriting data in the storage device 54.

The battery voltage detection circuit 51 detects the battery voltage of the battery 130, for example, at intervals of 5 to 10 seconds, and outputs the detected value to the control circuit 60.

In the ROM 52, a program executed by the control circuit 60 and data used for the execution of the program are stored.

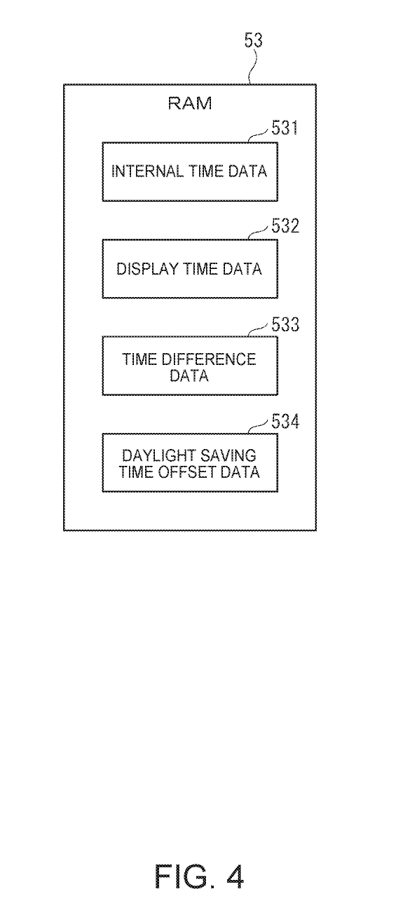

In the RAM 53, internal time data 531, display time data 532, time difference data 533, and daylight savings time offset data 534 are stored, as shown in FIG. 4.

As the internal time data 531, internal time showing UTC is stored. The internal time is updated by a timekeeping unit 61, described later, of the control circuit 60.

As the display time data 532, display time is stored which is obtained by adding the time difference of the time difference data 533 and daylight savings time setting information of the daylight savings time offset data 534 to the internal time of the internal time data 531. The display time is the time information displayed by the hands 21, 22, 23.

Procedures for setting the time difference data 533 and the daylight savings time offset data 534 will be described later.

Referring back to FIG. 3, the storage device 54 as a storage unit is configured of a rewritable non-volatile memory. Such a non-volatile memory may be, for example, an EEPROM (electronically erasable and programmable read-only memory), flash memory or the like. The storage device 54 may be externally attached to the control device 100.

In the storage device 54, local time setting data 541 and daylight savings time reference data 542 are stored.

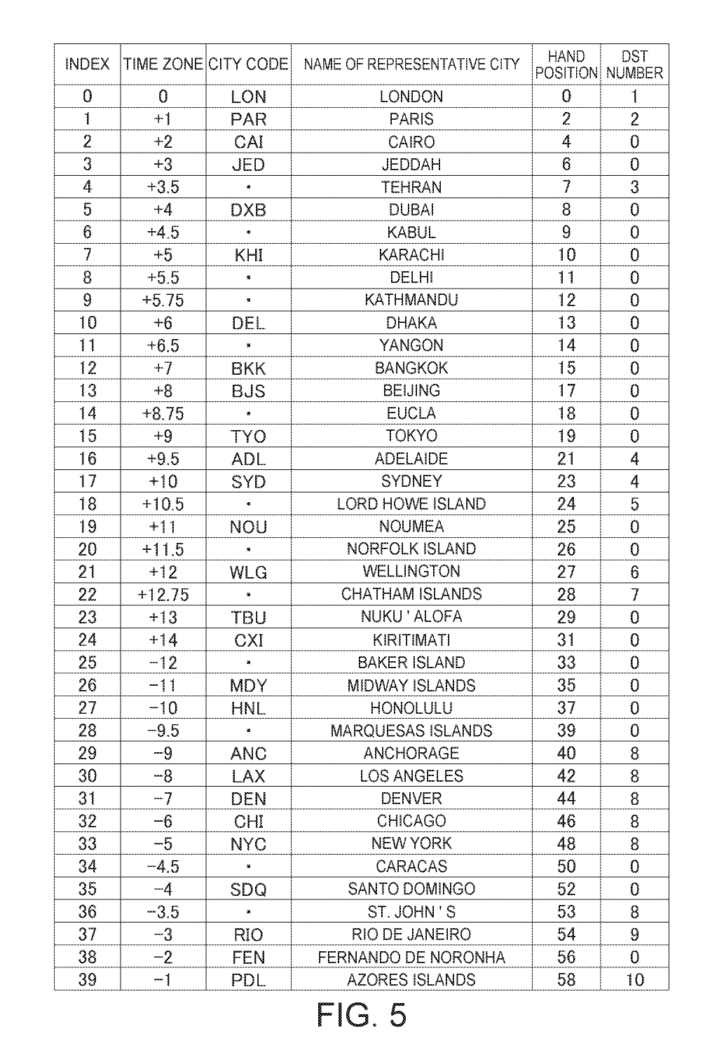

FIG. 5 shows an example of the local time setting data 541.

As the local time setting data 541, time difference (time zone) with an index, city code indicating a name of representative city, name of representative city, hand position, and DST number are stored in association with each other.

The index is a serial number, which is an integer equal to or greater than 0.

The time difference is the time difference from UTC. For example, “0” indicates that the time difference from UTC is 0 hours. “+1” indicates that the time difference from UTC is +1 hour. “−1” indicates that the time difference from UTC is −1 hour. In the case of the local time setting data 541 shown in FIG. 5, 40 time differences, from −12 hours to +14 hours, are stored. In the embodiment, the time difference is equivalent to region information.

The name of representative city is the name of a representative city in the region with the corresponding time difference.

The hand position indicates the position (second position) pointed at by the hand 21, which is the second hand. For example, “0” indicates a 0-second position. “2” indicates a 2-second position.

The DST number shows a corresponding number of the DST numbers of “0” to “10”, described later, stored as the daylight savings time reference data 542.

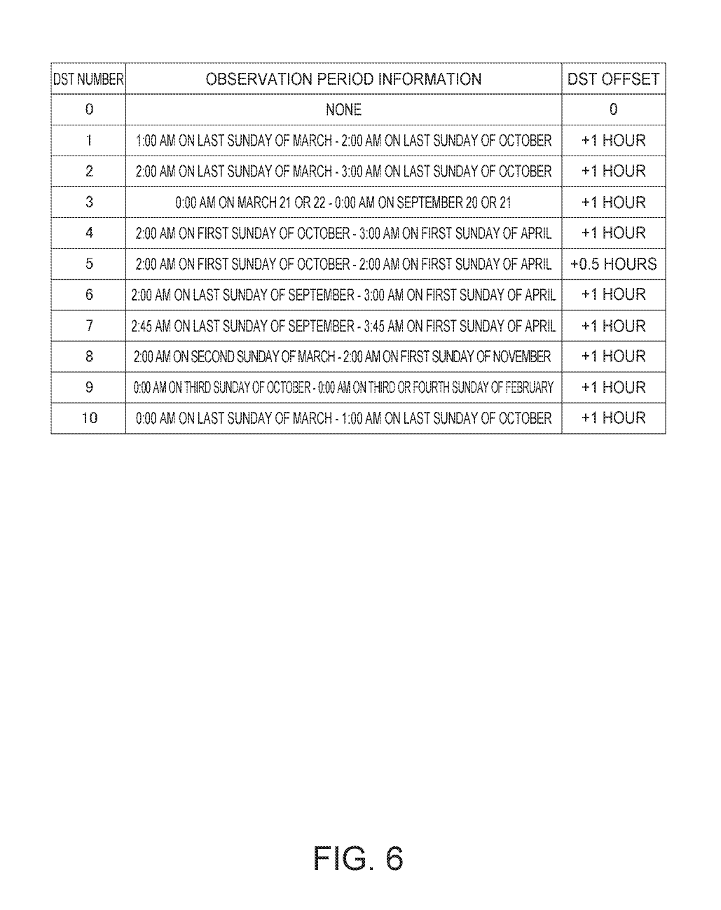

FIG. 6 shows an example of the daylight savings time reference data 542.

The daylight savings time reference data 542 includes DST number, observation period information representing the observation period of daylight savings time, and daylight savings time setting information (DST offset).

The daylight savings time setting information is information of the time difference from standard time and shows the time by which clocks are adjusted forward from standard time.

The daylight savings time reference data 542 stores a DST number which is an integer equal to or greater than 1 as information indicating that it is a region where daylight savings time is observed, the observation period information of daylight savings time, and the daylight savings time setting information.

The daylight savings time reference data 542 also stores a DST number “0” as information indicating that it is a region where daylight savings time is not observed. If the DST number is “0”, the daylight savings time reference data 542 does not store the observation period information and the daylight savings time setting information. Alternatively, if the DST number is “0”, the observation period information stores information that “daylight savings time is not observed”.

In the embodiment, the DST number included in the local time setting data 541 and the daylight savings time reference data 542 are an example of a daylight savings time observation rule.

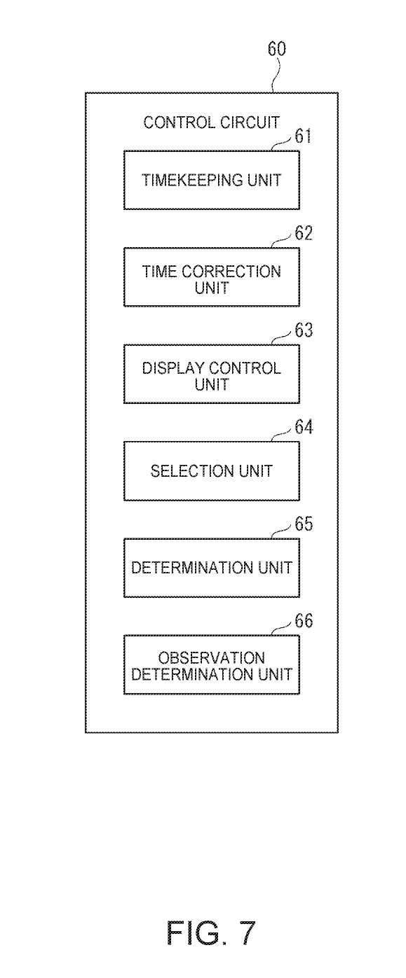

As shown in FIG. 7, the control circuit 60 executes various programs stored in the ROM 52 and thus functioning as a timekeeping unit 61 (timekeeper), a time correction unit 62 (time corrector), a display control unit 63 (display controller), a selection unit 64 (selector), a determination unit 65 (determiner), and an observation determination unit 66 (observation determiner).

The timekeeping unit 61 updates the internal time data 531 stored in the RAM 53, using a reference signal based on an oscillation signal of a crystal oscillator, not illustrated, provided in the electronic timepiece 1, and thus keeps the internal time.

The time correction unit 62 corrects the display time of the display time data 532.

The display control unit 63 controls the drive mechanism 140 to control the movement of the hands 21 to 23 so as to display the display time, and also to control the movement of the hand 24 so as to display various kinds of information.

The selection unit 64 selects a time difference as region information in response to an operation on the manual operation unit 40.

The determination unit 65 determines whether or not information indicating that it is a region where daylight savings time is observed is stored, in the daylight savings time observation rule corresponding to the time difference (region information) selected by the selection unit 64.

The observation determination unit 66 determines whether daylight savings time is currently observed or not, based on the observation period information.

Details of the respective functional units of the control circuit 60 will be described in the explanation of local time setting processing, given below.

### Local Time Setting Processing

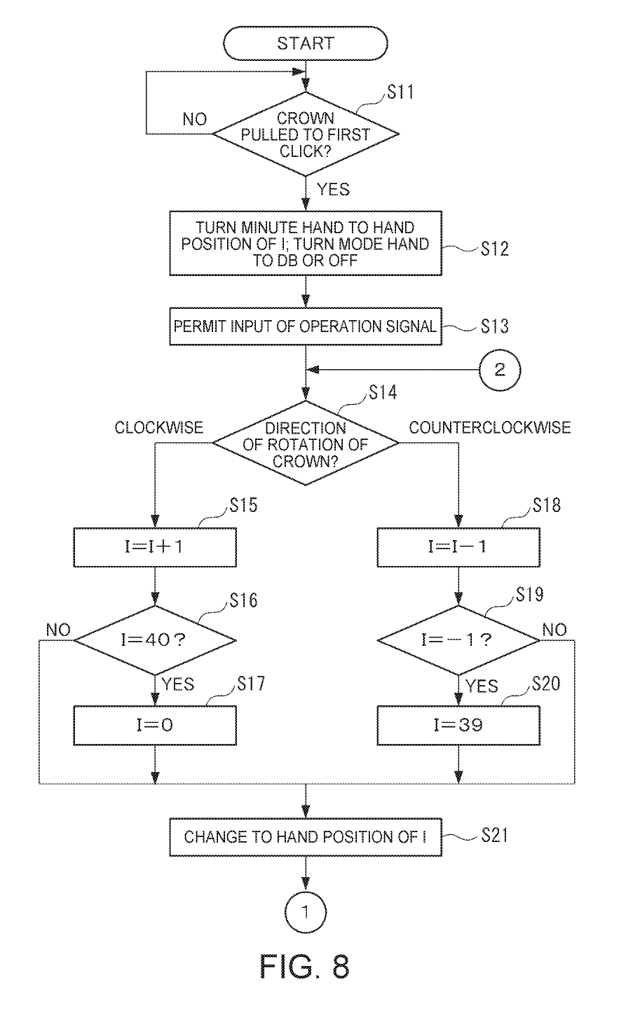

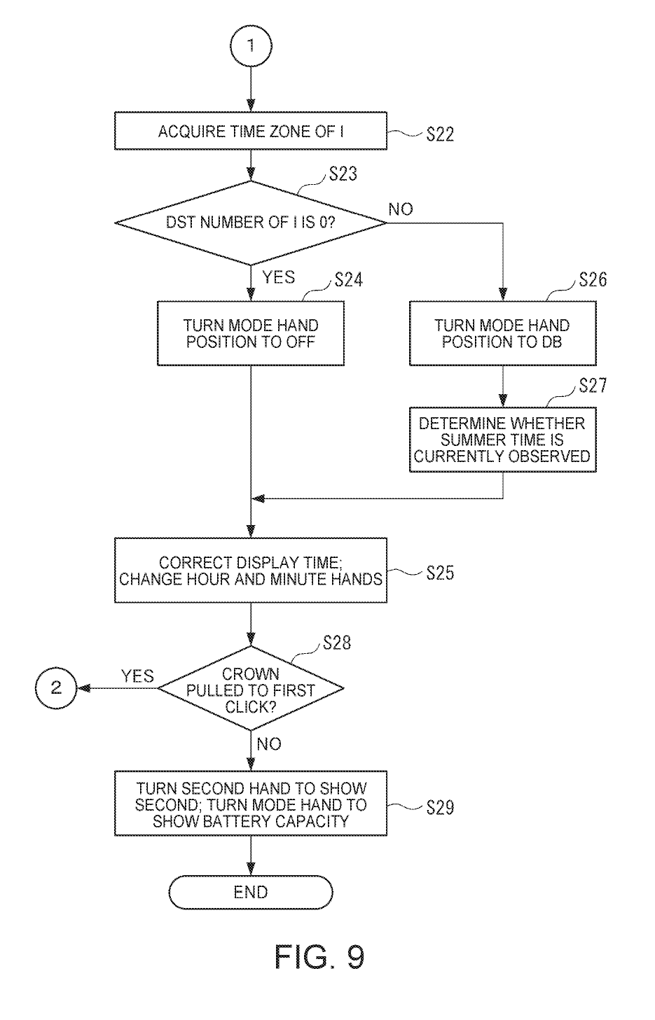

FIGS. 8 and 9 are flowcharts showing the local time setting processing executed by the electronic timepiece 1.

The control circuit 60 determines whether the crown 43 is pulled out to the first click or not (S11). If the result of the determination in step S11 is NO, the control circuit 60 repeats the execution of the processing of step S11.

If the result of the determination in step S11 is YES, the control circuit 60 sets the index number of the currently set time difference, as a variable I. The display control unit 63 causes the hand 21, which is the second hand, to point at the hand position corresponding to the index I in the local time setting data 541 (S12).

If it is determined that information that indicates that it is a region where daylight savings time is observed is stored in the storage device 54, based on the daylight savings time observation rule corresponding to the index I, the display control unit 63 causes the hand 24, which is the mode hand, to point at “DB”. Meanwhile, if it is determined that information that indicates that it is a region where daylight savings time is observed is not stored in the storage device 54, based on the daylight savings time observation rule, the display control unit 63 causes the hand 24 to point at “OFF”. The determination of whether information that indicates that it is a region where daylight savings time is observed is stored in the storage device 54 or not is carried out by a method similar to step S23, described later.

The control circuit 60 then permits the input of an operation signal outputted from the manual operation unit 40 (S13).

When the selection unit 64 detects that the crown 43 is rotated and that a time difference selection operation is carried out, based on the operation signal outputted from the manual operation unit 40, the selection unit 64 determines whether the direction of rotation of the crown 43 is clockwise or counterclockwise (S14).

If the direction of rotation of the crown 43 is clockwise, the selection unit 64 determines that an up-operation to select a time difference with an index number that is greater by one is carried out, and therefore the selection unit 64 adds 1 to the value of I (S15).

Next, the selection unit 64 determines whether or not the value of I is “40”, which is the maximum value “39” plus 1 (S16). If the result of the determination in step S16 is NO, the selection unit 64 advances the processing to step S21.

If the result of the determination in step S16 is YES, the selection unit 64 changes the value of I to 0 (S17) and advances the processing to step S21.

That is, if an up-operation is carried out when a time difference with the index being the maximum value is selected, the selection unit 64 selects a time difference with the index being the minimum value.

Meanwhile, if the direction of rotation of the crown 43 is counterclockwise, the selection unit 64 determines that a down-operation to select a time difference with an index number that is smaller by one is carried out, and therefore the selection unit 64 subtracts 1 from the value of I (S18).

Next, the selection unit 64 determines whether the value of I is −1 or not (S19). If the result of the determination in step S19 is NO, the selection unit 64 advances the processing to step S21.

If the result of the determination in step S19 is YES, the selection unit 64 changes the value of I to the maximum value “39” (S20) and advances the processing to step S21.

That is, if a down-operation is detected when a time difference with the index being the minimum value is selected, the selection unit 64 selects a time difference with the index being the maximum value.

In step S21, the display control unit 63 causes the hand 21 to point at the hand position corresponding to the index I in the local time setting data 541.

The time correction unit 62 acquires the time difference (time zone) corresponding to the index I from the local time setting data 541 (S22).

Next, the determination unit 65 determines whether the DST number corresponding to the index I in the local time setting data 541 is 0 or not (S23). That is, the determination unit 65 determines whether information that the region corresponding to the index I is a region where daylight savings time is not observed is stored in the storage device 54 or not.

If the result of the determination in step S23 is YES, that is, if information that the region corresponding to the index I is a region where daylight savings time is not observed is stored in the storage device 54, that is, if the DST number is 0, the display control unit 63 causes the hand 24 to point at “OFF”, thus showing that information that indicates that it is a region where daylight savings time is not observed is stored in the storage device 54 (S24).

The time correction unit 62 sets the time difference acquired in step S22 as the time difference data 533 and sets 0 hours as the daylight savings time offset data 534 (initializes the daylight savings time offset data 534), thus correcting the display time of the display time data 532 (S25). The display control unit 63 then causes the hands 22, 23 to show the hour and minute of the display time. The hour and minute of the time reflecting the selected time difference is thus displayed.

Meanwhile, if the result of the determination in step S23 is NO, that is, if the DST number corresponding to the index I is an integer equal to or greater than 1 and a daylight savings time observation rule indicating that daylight savings time is observed in this region is stored in the storage device 54, the display control unit 63 causes the hand 24 to point at “DB”, thus showing that a daylight savings time observation rule indicating that daylight savings time is observed in this region is stored in the storage device 54 (S26).

The observation determination unit 66 determines whether daylight savings time is currently observed or not, based on the observation period information corresponding to the index I (S27).

In step S25, if it is determined in step S27 that daylight savings time is not currently observed, the time correction unit 62 sets the time difference acquired in step S22 as the time difference data 533 and sets 0 hours as the daylight savings time offset data 534 (initializes the daylight savings time offset data 534), thus correcting the display time of the display time data 532. The display control unit 63 then causes the hands 22, 23 to show the hour and minute of the display time. The hour and minute of the time reflecting the selected time difference is thus displayed.

If it is determined in step S27 that daylight savings time is currently observed, the time correction unit 62 sets the time difference acquired in step S22 as the time difference data 533, and acquires the daylight savings time setting information corresponding to the index I from the daylight savings time reference data 542 and set the acquired daylight savings time setting information as the daylight savings time offset data 534, thus correcting the display time of the display time data 532. The display control unit 63 then causes the hands 22, 23 to show the hour and minute of the display time. The hour and minute of the time reflecting the selected time difference and the daylight savings time setting information corresponding to the time difference is thus displayed.

After the processing of step S25, the selection unit 64 determines whether the crown 43 is maintained in the state of being pulled out to the first click or not (S28). If the result of the determination in step S28 is YES, the selection unit 64 returns the processing to step S14 and executes the processing of steps S14 to S28 again.

If the result of the determination in step S28 is NO, that is, if the crown 43 is moved from the state of being pulled out to the first click, the display control unit 63 causes the hand 21 to show the second of the display time (S29). The display control unit 63 also causes the hand 24 to show the battery capacity. The control circuit 60 then ends the local time setting processing.

With the foregoing local time setting processing, for example, if the index number 15 (Tokyo) is selected, +9 hours is set as the time difference data 533. Since the DST number is 0 and information that indicates that it is a region where daylight savings time is not observed is stored, the hand 24 points at OFF and 0 hours is set as the daylight savings time offset data 534. Thus, time equal to UTC plus 9 hours is displayed.

If the index number 33 (New York) is selected, −5 hours is set as the time difference data 533. Since the DST number is 8 and information that indicates that it is a region where daylight savings time is observed is stored, the hand 24 points at DB.

Here, the observation period expressed by the observation period information corresponding to the DST number 8 is from 2:00 am on the second Sunday of March to 2:00 am on the first Sunday of November. For example, if the current time is January, daylight savings time is not currently observed and therefore 0 hours is set as the daylight savings time offset data 534. Thus, time equal to UTC minus 5 hours is displayed. Meanwhile, for example, if the current time is April, daylight savings time is currently observed and therefore +1 hour is set as the daylight savings time offset data 534. Thus, time equal to UTC minus 4 hours is displayed.

In the embodiment, the up-operation and down-operation, which are time difference selection operations, are carried out by rotating the crown 43. However, this is not limiting. For example, the up-operation may be carried out by pressing the A-button 41, and the down-operation may be carried out by pressing the B-button 42.

In the embodiment, every time a time difference selection operation is carried out, the display control unit 63 controls the movement of the hands 22, 23 to show the hour and minute of the display time. However, this is not limiting. For example, in step S29, the hands 22, 23 may be moved at the same timing as the hand 21.

### Daylight Savings Time Switching Processing

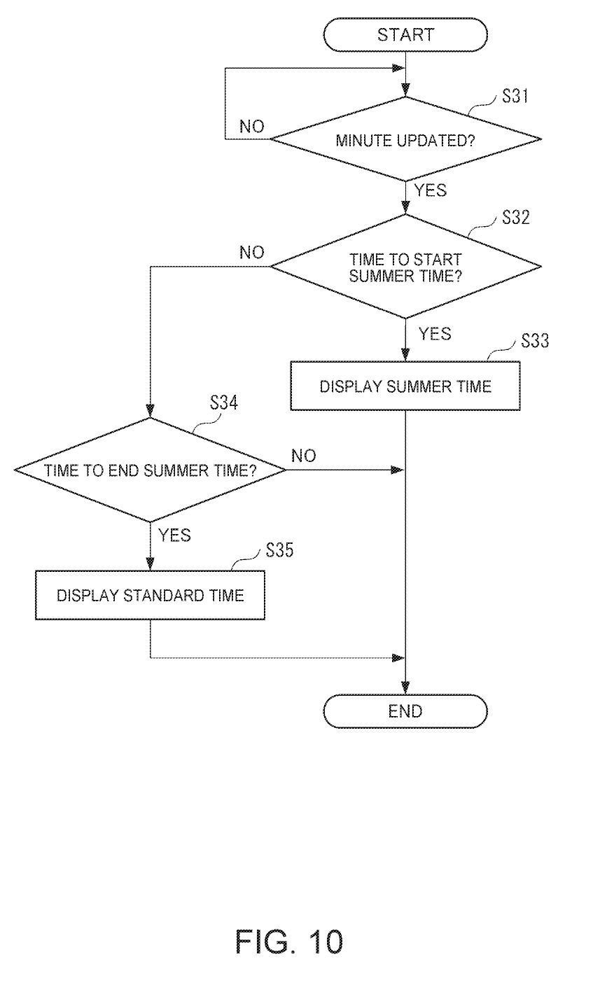

FIG. 10 is a flowchart showing daylight savings time switching processing executed by the electronic timepiece 1. The daylight savings time switching processing is executed if information that indicates that it is a region where daylight savings time is observed is stored in the storage device 54, based on the daylight savings time observation rule corresponding to the region information (in this embodiment, the time difference) selected by the selection unit 64.

The time correction unit 62 determines whether the minute of the internal time is updated by the timekeeping unit 61 or not (S31).

If the result of the determination in step S31 is YES, the time correction unit 62 determines whether it is the time to start daylight savings time or not, referring to the observation period information of the daylight savings time observation rule corresponding to the region information selected by the selection unit 64 (S32).

If the result of the determination in step S32 is YES, the time correction unit 62 sets the daylight savings time setting information corresponding to the selected region information as the daylight savings time offset data 534. Thus, the display time is advanced by the daylight savings time setting information and daylight savings time is displayed (S33). A minute later, the time correction unit 62 carries out the processing of step S31 again.

Meanwhile, if the result of the determination in step S32 is NO, the time correction unit 62 determines whether it is time to end daylight savings time or not, referring to the observation period information of the daylight savings time observation rule corresponding to the region information selected by the selection unit 64 (S34).

The result of the determination in step S34 is NO before the daylight savings time observation period starts or during the daylight savings time observation period. A minute later, the time correction unit 62 carries out the processing of step S31 again.

The result of the determination in step S34 is YES after daylight savings time is displayed in step S33 or when the daylight savings time observation period ends. The time correction unit 62 sets 0 hours as the daylight savings time offset data 534. Thus, the display time is shifted back by the daylight savings time setting information and standard time is displayed (S35). A minute later, the time correction unit 62 carries out the processing of step S31 again.

### Advantageous Effects of First Embodiment

With the electronic timepiece 1, in the local time setting processing, if information that indicates that it is a region where daylight savings time is observed is stored, based on the daylight savings time observation rule corresponding to a selected region information, information that indicates that it is a region where daylight savings time is observed is displayed (the hand 24 points at “DB”), whereas if information that indicates that it is a region where daylight savings time is observed is not stored, based on the daylight savings time observation rule corresponding to the selected region information, information that indicates that it is not a region where daylight savings time is observed is displayed (the hand 24 points at “OFF”).

This enables the user to grasp whether a daylight savings time observation rule indicating that the selected region is a region where daylight savings time is observed is stored in the electronic timepiece 1 or not.

Therefore, the user understands that the information in the storage device 54 does not correspond to the selected region, if information that indicates that it is not a region where daylight savings time is observed is displayed (the hand 24 points at “OFF”) even when a region where daylight savings time is observed is selected, or if information that indicates that it is a region where daylight savings time is observed is displayed (the hand 24 points at “DB”) even when a region where daylight savings time is not observed is selected. Thus, if information that indicates that it is not a region where daylight savings time is observed is displayed even when a region where daylight savings time is observed is selected, the user can take measures such as manually correcting the time during the daylight savings time observation period. If information that indicates that it is a region where daylight savings time is observed is displayed even when a region where daylight savings time is not observed is selected, the user can take measures such as operating and setting the electronic timepiece 1 not to show daylight savings time.

The user can also select the region information of a different region from the current location by operating the manual operation unit 40. Therefore, for example, when moving from Japan to a certain region abroad, the user can grasp in advance whether or not this region is stored in the electronic timepiece 1 as a region where daylight savings time is observed.

The electronic timepiece 1 executes the daylight savings time switching processing. Thus, when the daylight savings time observation period starts in the selected region, the electronic timepiece 1 can display daylight savings time without the user having to carry out an operation to display daylight savings time. Also, when the daylight savings time observation period ends, the electronic timepiece 1 can display standard time without the user having to carryout an operation to display standard time.

### Second Embodiment

An electronic timepiece 1A according to a second embodiment receives a satellite signal from a location information satellite and corrects the internal time and the time difference, based on the received satellite signal. The electronic timepiece 1A also selects region information, based on the received satellite signal. In the description below, the same components as those of the electronic timepiece 1 are denoted by the same reference signs and not described further in detail.

### Configuration of Electronic Timepiece

The electronic timepiece 1A is configured to receive a satellite signal from at least one GPS (global positioning system) satellite, of a plurality of GPS satellites circling in a predetermined orbit above the Earth, and thus acquire time information, and also to receive satellite signals from at least three GPS satellites and thus calculate and acquire location information.

### Schematic Configuration of Electronic Timepiece

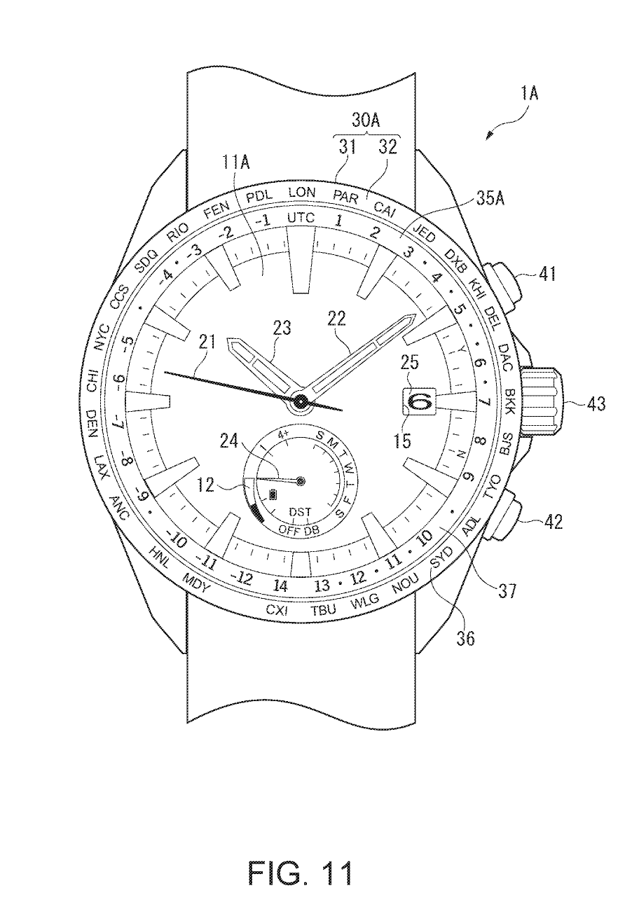

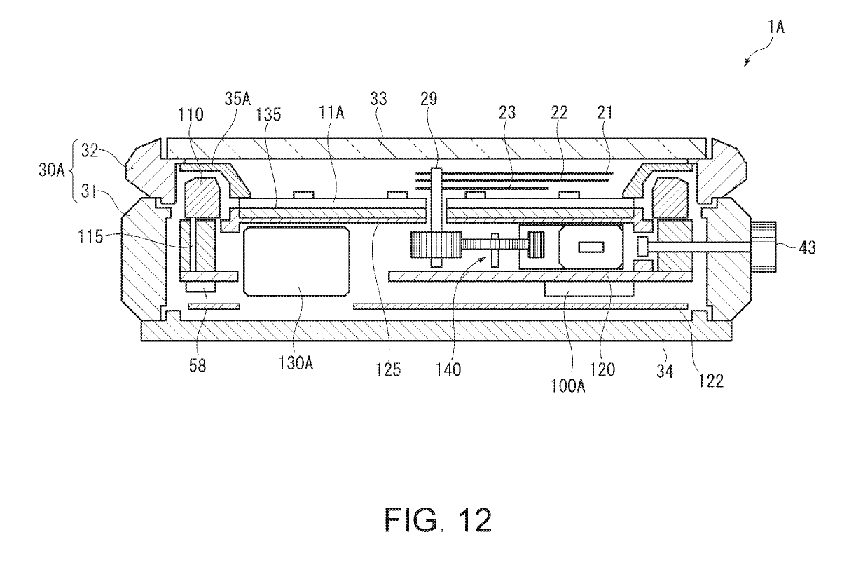

FIG. 11 is a front view of the electronic timepiece 1A. FIG. 12 is a cross-sectional view schematically showing the electronic timepiece 1A. Here, only the components different from those of the electronic timepiece 1 according to the first embodiment are described. The other parts of the configuration are not described further in detail.

In the electronic timepiece 1A, an outer case 30A is configured of a cylindrical case 31 made of metal and a bezel 32 made of ceramic and fitted on the face side of the case 31.

A dial ring 35A is made of plastic and is ring-shaped as viewed in a plan view and cone-shaped as viewed in a cross-sectional view. The dial ring 35A and the inner circumferential surface of the bezel 32 form a doughnut-shaped hosing space. In this housing space, a ring-shaped antenna unit 110 is housed.

A dial 11A is made of a light-transmissive material such as plastic.

A solar battery 135 which performs photovoltaic power generation is provided between the dial 11A and the bottom plate 125.

The circuit board 120 has a control device 100A and a GPS receiving device 58 on the back cover side. The circuit board 120 and the antenna unit 110 are connected together with an antenna connection pint 115.

In this embodiment, a secondary battery 130A such as a lithium-ion battery is used as the battery. The secondary battery 130A is recharged with electricity generated by the solar battery 135.

As shown in FIG. 11, on the dial ring 35A, the alphabet letter “Y” is given at the position of 12 minutes and the alphabet letter “N” is given at the position of 18 minutes. A press on the A-button 41 causes the hand 21 to point at one of “Y” and “N”, thus showing the result of the previous reception of a satellite signal. That is, the hand 21 points at “Y” if it is success. The hand 21 points at “N” if it is failure.

On the outer circumference of the rotation area of the hand 24, the number “1” and the symbol “4+” are given. These number and symbol express satellite signal reception modes. The number “1” means receiving time information and correcting the internal time (time measuring mode). The symbol “4+” means receiving time information and orbit information, then calculating location information of the current location, and correcting the internal time and the time difference (positioning mode).

### Circuit Configuration of Electronic Timepiece

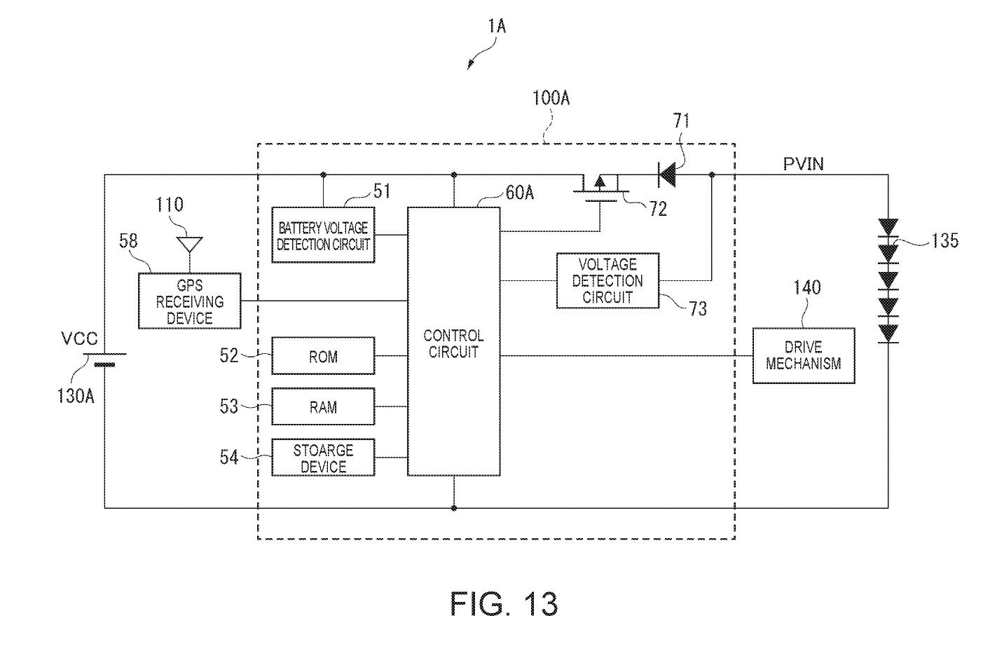

FIG. 13 shows the circuit configuration of the electronic timepiece 1A.

As shown in FIG. 13, the electronic timepiece 1A has the GPS receiving device 58 connected to the control device 100A, as a satellite signal receiving unit. The control device 100A has a diode 71, a charging control switch 72, and a voltage detection circuit 73.

The diode 71 is provided in a path that electrically connects the solar battery 135 to the secondary battery 130A. The diode 71 shuts down the current from the secondary battery 130A to the solar battery 135 (reverse current) without shutting down the current from the solar battery 135 to the secondary battery 130A (forward current). The forward current flows only when the voltage of the solar battery 135 is higher than the voltage of the secondary battery 130A, that is, only at the time of charging. The diode 71 prevents the current from flowing from the secondary battery 130A to the solar battery 135 when the voltage of the solar battery 135 is lower than the voltage of the secondary battery 130A.

The charging control switch 72 connects and disconnects that path of the current from the solar battery 135 to the secondary battery 130A. The charging control switch 72 has a switching element provided in the path electrically connecting the solar battery 135 to the secondary battery 130A. When the switching element shifts from off-state to on-state, the charging control switch 72 connects the path. When the switching element shifts from on-state to off-state, the charging control switch 72 disconnects the path.

The voltage detection circuit 73 operates based on a control signal which designates a timing of voltage detection. In a period when the charging control switch 72 is in off-state, the voltage detection circuit 73 detects a terminal voltage PVIN of the solar battery 135, that is, the output voltage of the solar battery 135. The voltage detection circuit 73 outputs the result of the detection to a control circuit 60A.

The GPS receiving device 58 is connected to the antenna unit 110, processes a satellite signal received via the antenna unit 110, and thus acquires time information and location information. The antenna unit 110 received radio waves of a satellite signal transmitted from a GPS satellite and passing through the glass cover 33 and the dial ring 35A.

Although not illustrated, the GPS receiving device 58, similarly to an ordinary GPS device, includes an RF (radio frequency) unit which receives a satellite signal transmitted from a GPS satellite and converts the received satellite signal into a digital signal, a BB unit (baseband unit) which executes correlation determination on the received signal and demodulates a navigation message, and an information acquisition unit which processes the navigation message (satellite signal) demodulated by the BB unit and acquires and outputs time information and location information.

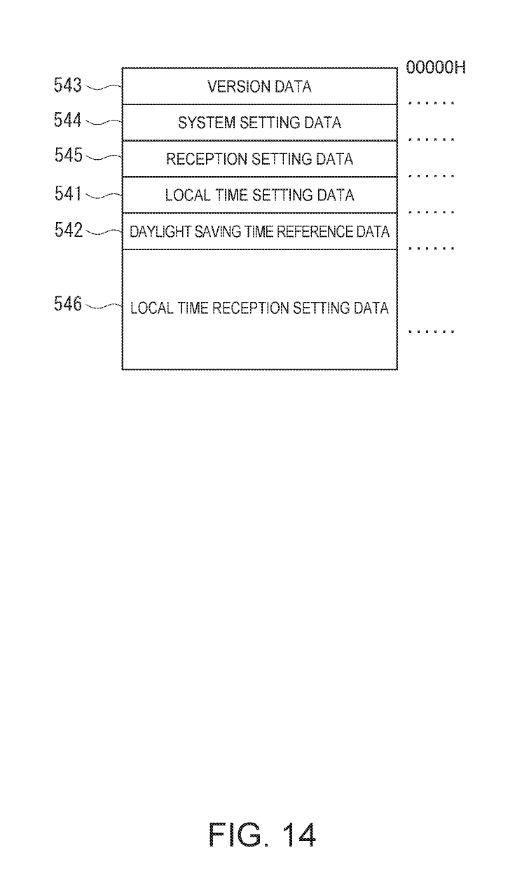

FIG. 14 shows the configuration of data stored in the storage device 54 of the electronic timepiece 1A.

In the storage device 54, system setting data 544 for driving the electronic timepiece 1A, reception setting data 545, local time reception setting data 546, described later, are version data 543 representing the version of each data, in addition to the local time setting data 541 and the daylight savings time reference data 542, are stored at predetermined addresses.

Since the storage device 54 is rewritable, the local time setting data 541, the system setting data 544, the reception setting data 545, the local time reception setting data 546, and the version data 543 can be updated.

As the system setting data 544, for example, a parameter such as clock rate information or step motor drive setting information is stored.

As the reception setting data 545, a parameter such as the interval of automatic reception of satellite signals in the reception processing by the GPS receiving device 58 or time-out time until the reception processing ends if no satellite signal can be captured or the like is stored.

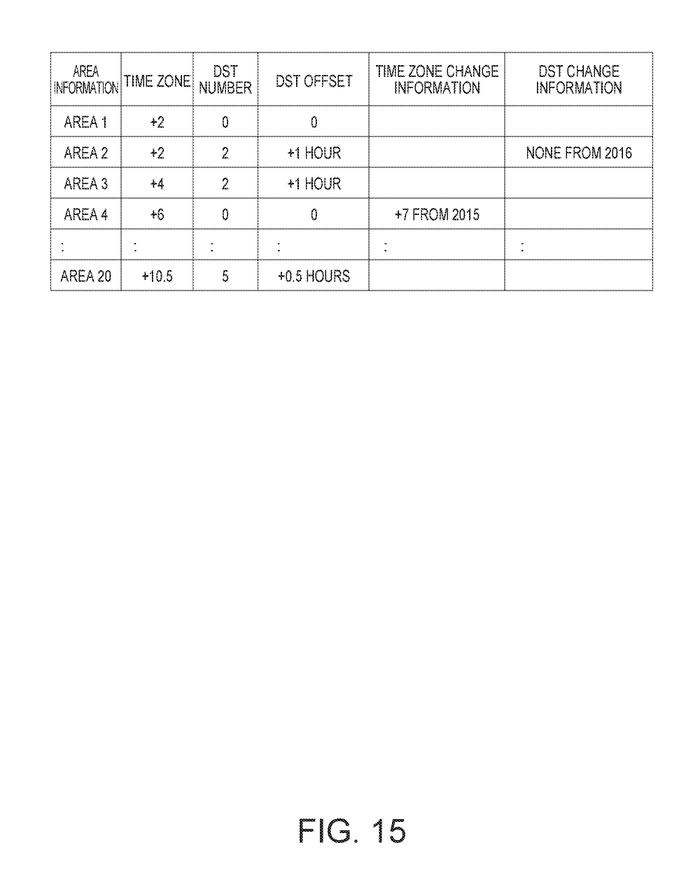

FIG. 15 shows an example of the local time reception setting data 546.

As local time reception setting data 546, area information, time difference (time zone), DST number, daylight savings time setting information (DST offset), time difference change information (time zone change information), and daylight savings time change information (DST change information) are stored in association with each other. In this embodiment, the daylight savings time observation rule includes the DST number of the local time reception setting data 546.

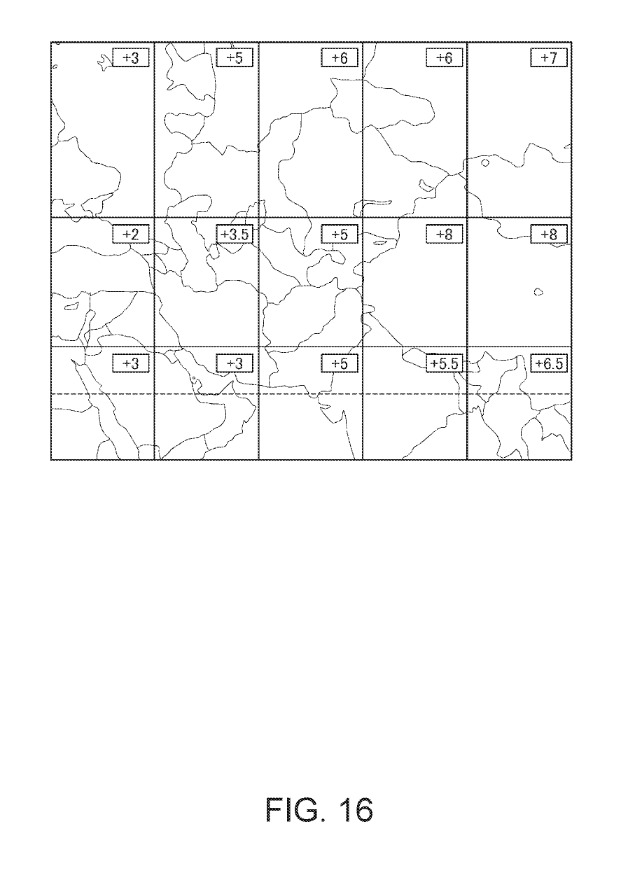

The area information is information representing each area formed by dividing geographic information into a plurality of areas, as shown in FIG. 16. Each area is, for example, a rectangular area approximately 1000 to 2000-km long in east-west and north-south directions. As the area information, coordinate data to specify each area is stored. That is, a rectangular area can be specified, for example, by the coordinates (longitude, latitude) at the top left of the area and the coordinates (longitude, latitude) at the bottom right of the area. Therefore, the coordinates of the two points are stored.

Thus, when location information is acquired in the positioning mode, the control circuit 60A can select the area information, based on the location information (latitude, longitude). In this embodiment, the area information, too, is equivalent to region information.

Referring back to FIG. 15, the time difference change information is information about change to time difference that is scheduled in the future. The daylight savings time change information is information about change to daylight savings time that is scheduled in the future. Based on the time difference change information, the control circuit 60A changes the time difference of the local time reception setting data 546 as the time to change the time difference has come. Also, based on the daylight savings time change information, the control circuit 60A changes the daylight savings time setting information of the local time reception setting data 546 as the time to change daylight savings time has come.

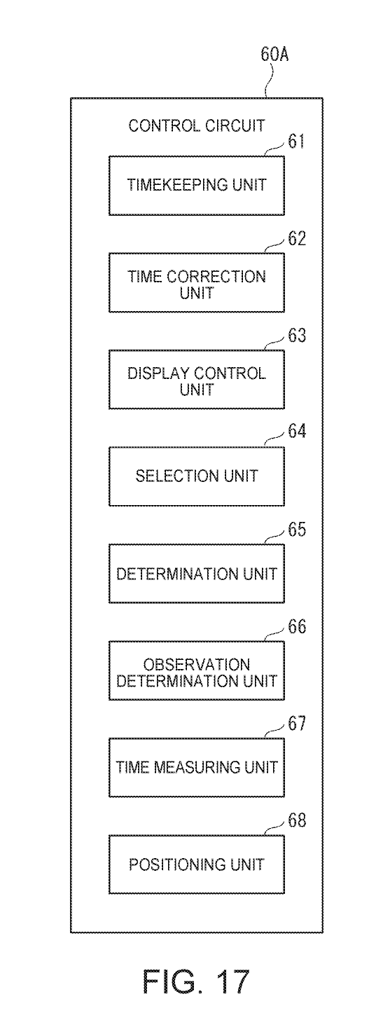

The control circuit 60A functions as a timekeeping unit 61 (timekeeper), a time correction unit 62 (time corrector), a display control unit 63 (display controller), a selection unit 64 (selector), a determination unit 65 (determiner), an observation determination unit 66 (observation determiner), a time measuring unit 67 (time measurer), and a positioning unit 68 (positioner), as shown in FIG. 17.

The time measuring unit 67 determines that an automatic reception condition is met, if an automatic reception timing that is set at a predetermined interval has come, or if the amount of light cast on the electronic timepiece 1A is equal to or greater than a predetermined amount of light and therefore it can be determined that sunlight is cast on the electronic timepiece 1A outdoors. This actuates the GPS receiving device 58 to execute reception processing in the time measuring mode. Also, the time measuring unit 67 actuates the GPS receiving device 58 to execute the reception processing in the time measuring mode, if the A-button 41 is pressed for 3 seconds or more, and less than 6 seconds to carryout a forced reception operation in the time measuring mode. Executing the reception processing in the time measuring mode, the GPS receiving device 58 captures at least one GPS satellite, receives a satellite signal transmitted from the GPS satellite, and acquires time information.

The positioning unit 68 actuates the GPS receiving device 58 to execute reception processing in the positioning mode, if the A-button 41 is pressed for 6 seconds or longer to carry out a forced reception operation in the positioning mode. Executing the reception processing in the positioning mode, the GPS receiving device 58 captures at least three, preferably four or more GPS satellites, receives a satellite signal transmitted from each of these GPS satellites, and calculates and acquires location information. The GPS receiving device 58 can also acquire time information at the same time when receiving the satellite signal.

In this embodiment, if the automatic reception condition is met, the reception processing in the time measuring mode is carried out. However, it is possible to allow a choice to carry out the reception processing in the positioning mode.

In this embodiment, the selection unit 64 not only selects the time difference as the region information in response to an operation on the manual operation unit 40 but also selects the area information as the region information, based on the location information acquired by the reception processing in the positioning mode.

The determination unit 65 determines whether or not information indicating that it is a region where daylight savings time is observed is stored, based on the daylight savings time observation rule corresponding to the time difference or area information selected by the selection unit 64.

In the electronic timepiece 1A, when the reception processing in the time measuring mode is executed, the time correction unit 62 updates the internal time data 531 with the acquired time information and thus corrects the internal time.

The reception processing in the positioning mode will be described in the following explanation of local time reception setting processing.

### Local Time Reception Setting Processing

The electronic timepiece 1A executes the following local time reception setting processing in addition to the local time setting processing described in the first embodiment.

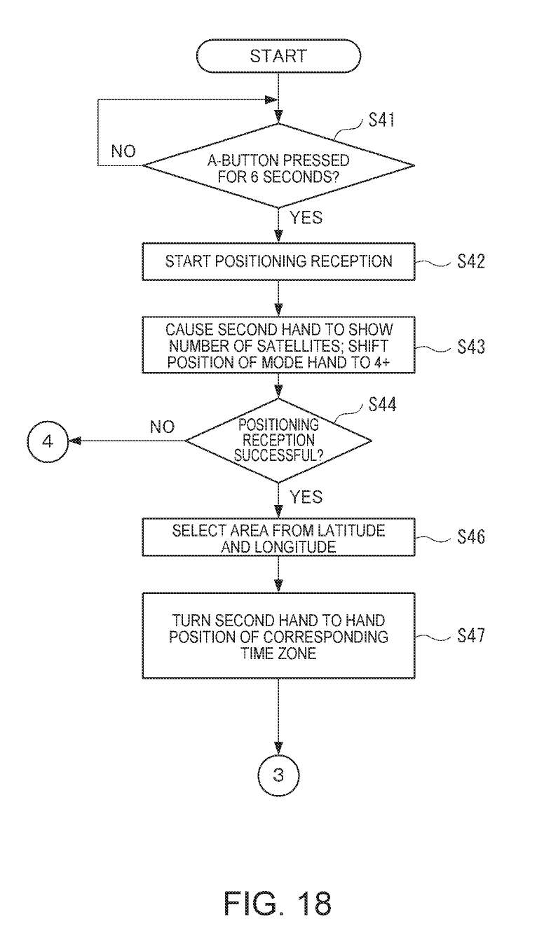

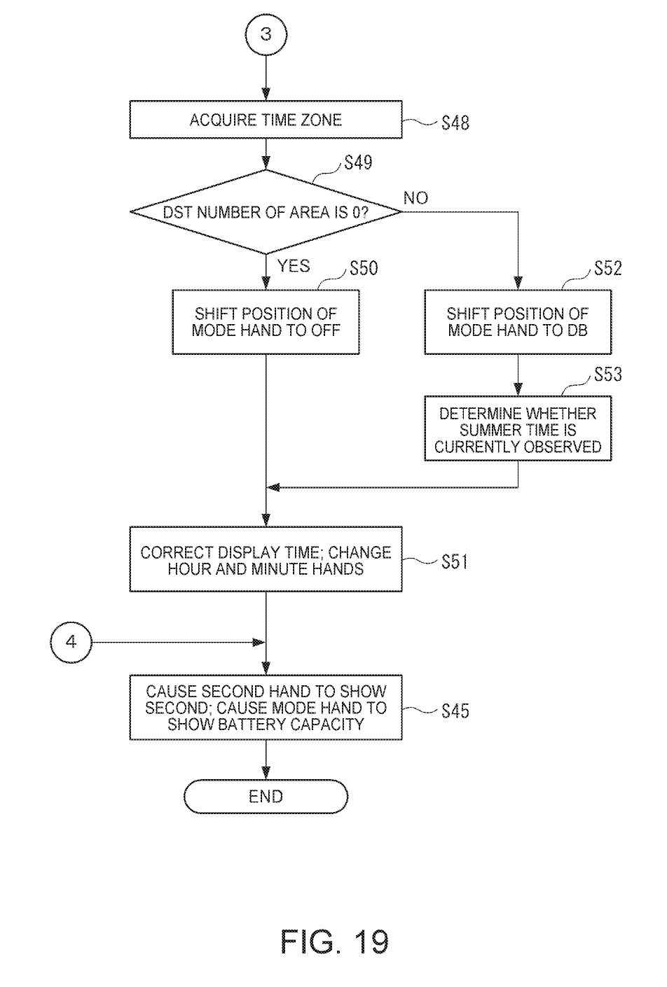

FIGS. 18 and 19 are flowcharts showing the local time reception setting processing executed by the electronic timepiece 1A.

The positioning unit 68 determines whether the A-button 41 is pressed for 6 seconds or not (S41). If the result of the determination in step S41 is NO, the positioning unit 68 repeats the execution of the processing of step S41.

If the result of the determination in step S41 is YES, the positioning unit 68 actuates the GPS receiving device 58 to start the reception processing in the positioning mode (S42).

The display control unit 63 causes the hand 21 to show the number of GPS satellites that are captured (number of captured satellites) (S43). Specifically, the display control unit 63 causes the hand 21 to point at the position indicating the value of the hour corresponding to the value of the number of captured satellites, of the positions indicating the values of the hour of 0 to 11, and thus display the number of captured satellites. For example, if the number of captured satellites is 5, the display control unit 63 causes the hand 21 to point at the position of 5 o'clock (position of 25 seconds).

Also, in step S43, the display control unit 63 causes the hand 24 to point at “4+” and thus display that the reception mode is the positioning mode.

Next, the positioning unit 68 determines whether the positioning reception is successful or not, that is, whether the acquisition of location information is successful or not (S44).

If the result of the determination in step S44 is NO, the display control unit 63 causes the hand 21 to show the second of the display time and causes the hand 24 to show the battery capacity (S45). The control circuit 60A then ends the local time reception setting processing.

Meanwhile, if the result of the determination in step S44 is YES, the selection unit 64 selects area information to which the acquired location information (latitude, longitude) belong, from among the area information of the local time reception setting data 546 (S46).

Next, the display control unit 63 causes the hand 21 to point at the time difference corresponding to the area information selected from the local time reception setting data 546 (S47).

The time correction unit 62 then acquires the time difference (time zone) corresponding to the selected area information from the local time reception setting data 546 (S48).

Next, the determination unit 65 determines whether the DST number corresponding to the selected area information is 0 or not, in the local time reception setting data 546 (S49). That is, the determination unit 65 determines whether or not information that indicates that it is not a region where daylight savings time is observed is stored in the storage device 54, based on the daylight savings time observation rule corresponding to the selected area information.

If the result of the determination in step S49 is YES, the display control unit 63 causes the hand 24 to point at “OFF” and thus display that information that indicates that it is not a region where daylight savings time is observed is stored in the storage device 54 (S50).

The time correction unit 62 then sets the time difference acquired in step S48 as the time difference data 533 and sets 0 hours as the daylight savings time offset data 534 (initializes the daylight savings time offset data 534), thus correcting the display time of the display time data 532 (S51). The display control unit 63 then causes the hands 22, 23 to show the hour and minute of the display time. The hour and minute of the time that reflects the time difference corresponding to the selected area information is thus displayed.

Meanwhile, if the result of the determination in step S49 is NO, the display control unit 63 causes the hand 24 to point at “DB” and thus display that information that indicates that it is a region where daylight savings time is observed is stored in the storage device 54 (S52).

The observation determination unit 66 then determines whether daylight savings time is currently observed or not, based on the observation period information of the daylight savings time observation rule corresponding to the selected area information (S53).

In step S51, if it is determined in step S53 that daylight savings time is not currently observed, the time correction unit 62 sets the time difference acquired in step S48 as the time difference data 533 and sets 0 hours as the daylight savings time offset data 534 (initializes the daylight savings time offset data 534), thus correcting the display time of the display time data 532. The display control unit 63 then causes the hands 22, 23 to show the hour and minute of the display time. The hour and minute of the time that reflects the time difference corresponding to the selected area information is thus displayed.

If it is determined in step S53 that daylight savings time is currently observed, the time correction unit 62 sets the time difference acquired in step S48 as the time difference data 533. The time correction unit 62 also acquires the daylight savings time setting information corresponding to the selected area information from the daylight savings time reference data 542, referring to the DST number, and sets the acquired daylight savings time setting information as the daylight savings time offset data 534. The time correction unit 62 thus corrects the display time of the display time data 532. The display control unit 63 then causes the hands 22, 23 to show the hour and minute of the display time. The hour and minute of the time that reflects the time difference corresponding to the selected area information and the daylight savings time setting information corresponding to the area information is thus displayed.

In step S45, after the processing of step S51, the display control unit 63 causes the hand 21 to show the second of the display time and causes the hand 24 to show the battery capacity. The control circuit 60A then ends the local time reception setting processing.

### Advantageous Effects of Second Embodiment

The second embodiment can achieve the same advantageous effects as the first embodiment, with the same configuration as the first embodiment. The second embodiment can also achieve the following advantageous effects.

That is, the user can select the region information of the current location by pressing the A-button 41 to receive a satellite signal. Therefore, the user can more easily select the region information of the current location than in the case of selecting the region information by operating each button 41, 42 and the crown 43 until the region information of the current location is selected.

### Third Embodiment

The electronic timepiece according to a third embodiment is configured of the electronic timepiece 1 of the first embodiment or the electronic timepiece 1A of the second embodiment with an additional function that enables switching between a daylight savings time automatic display mode in which the daylight savings time switching processing is executed and a daylight savings time non-display mode in which daylight savings time is not displayed. In the description below, the same components as those of the electronic timepieces 1, 1A are denoted by the same reference signs and are not described further in detail.

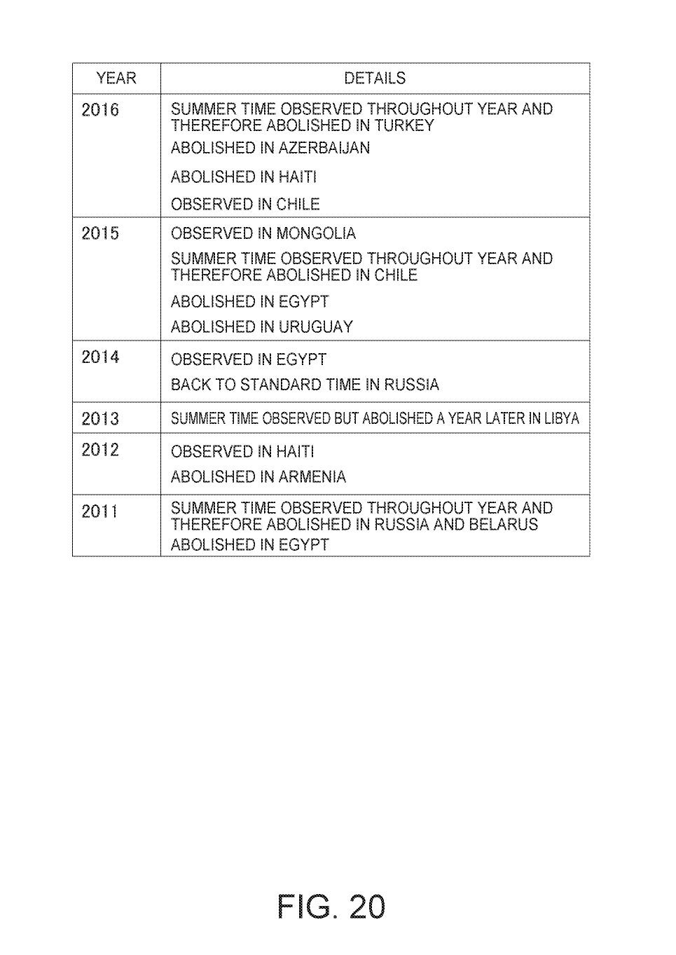

The status of observation of daylight savings time is changed every year, as shown in FIG. 20.

Therefore, if the local time setting data 541 or the daylight savings time reference data 542 stored in the electronic timepiece is not of the latest version, the electronic timepiece may fail to display daylight savings time even in a region where daylight savings time is observed, or may display daylight savings time even in a region where daylight savings time is not observed.

For example, in Haiti, daylight savings time had been observed since 2012 but was abolished in 2016. Therefore, if the data stored in the electronic timepiece is of the 2015 version, the electronic timepiece displays daylight savings time in Haiti even though daylight savings time is not observed.

Thus, the electronic timepiece of this embodiment is configured to be able to set the daylight savings time non-display mode, in which daylight savings time is not displayed.

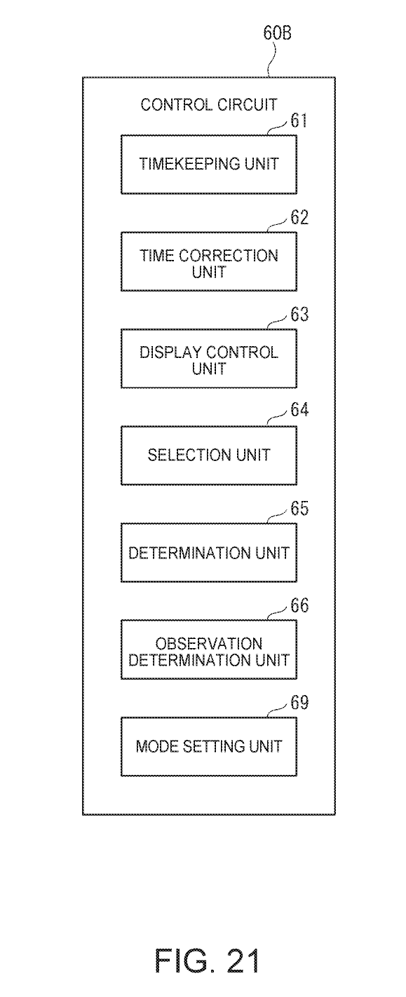

A control circuit 60B functions as a timekeeping unit 61 (timekeeper), a time correction unit 62 (time corrector), a display control unit 63 (display controller), a selection unit 64 (selector), a determination unit 65 (determiner), and a mode setting unit 69 (mode setter), as shown in FIG. 21. The control circuit 60B may function as a time measuring unit 67 and a positioning unit 68.

The mode setting unit 69 sets one of the daylight savings time automatic display mode and the daylight savings time non-display mode in response to an operation on the manual operation unit 40.

### Display Mode Switching Processing

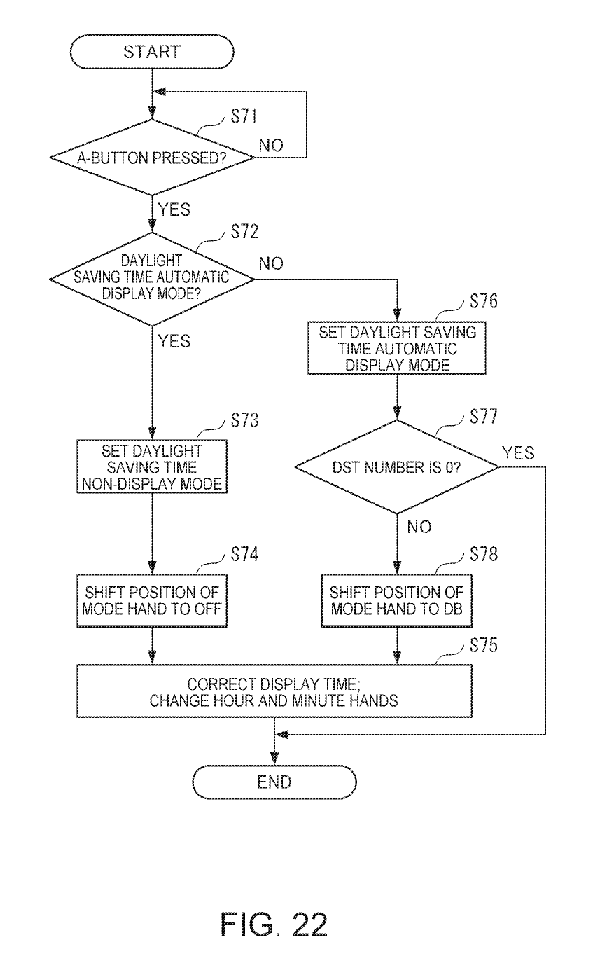

FIG. 22 is a flowchart showing display mode switching processing executed by the electronic timepiece of this embodiment. The display mode switching processing is executed by the time when a rotating operation on the crown 43 is carried out after the input an operation signal is permitted in step S13 in the local time setting processing shown in FIG. 8.

As the display mode switching processing is executed, the mode setting unit 69 determines whether the A-button 41 is pressed or not (S71). If the result of the determination in step S71 is NO, the mode setting unit 69 repeats the execution of the processing of step S71.

If the result of the determination in step S71 is YES, the mode setting unit 69 determines whether the currently set display mode is the daylight savings time automatic display mode or not (S72).

If the result of the determination in step S72 is YES, the mode setting unit 69 sets the daylight savings time non-display mode (S73).

The display control unit 63 then causes the hand 24 to point at “OFF”, thus showing that daylight savings time non-display mode is set (S74).

The time correction unit 62 sets 0 hours as the daylight savings time offset data 534 (initializes the daylight savings time offset data 534) and thus corrects the time display (S75). The display control unit 63 causes the hands 22, 23 to show the hour and minute of the display time. The control circuit 60B then returns the processing to step S71.

Meanwhile, if the result of the determination in step S72 is NO, the mode setting unit 69 sets the daylight savings time automatic display mode (S76). The daylight savings time switching processing shown in FIG. 10 is thus executed.

Next, the time correction unit 62 determines whether the DST number corresponding to the selected region information is 0 or not (S77). If the result of the determination in step S77 is YES, the display control unit 63 maintains the state where the hand 24 is pointing at “OFF”, thus showing that the daylight savings time automatic display mode is set and that information that indicates that it is a region where daylight savings time is observed is not stored in the storage device 54, based on the daylight savings time observation rule corresponding to the selected region information. That is, displaying “OFF” means that “the daylight savings time non-display mode is set” or that “the daylight savings time automatic display mode is set and that information that indicates that it is a region where daylight savings time is observed is not stored in the storage device 54, based on the daylight savings time observation rule corresponding to the selected region information”.

If the result of the determination in step S77 is NO, the display control unit 63 causes the hand 24 to point at “DB”, thus showing that the daylight savings time automatic display mode is set and that information that indicates that it is a region where daylight savings time is observed is stored in the storage device 54, based on the daylight savings time observation rule corresponding to the selected region information (S78).

In step S75, if daylight savings time is not currently observed, the time correction unit 62 sets 0 hours as the daylight savings time offset data 534 (initializes the daylight savings time offset data 534) and thus corrects the display time. Meanwhile, if daylight savings time is currently observed, the time correction unit 62 sets the daylight savings time setting information of the daylight savings time reference data 542 corresponding to the selected region information, as the daylight savings time offset data 534, and thus corrects the display time.

The display control unit 63 then causes the hands 22, 23 to show the hour and minute of the display time. The control circuit 60B returns the processing to step S71.

### Advantageous Effects of Third Embodiment

The third embodiment can achieve the same advantageous effects as the first and second embodiments, with the same configuration as the first and second embodiments. The third embodiment can also achieve the following advantageous effects.

That is, for example, if the data stored in the electronic timepiece is not of the latest version and information that daylight savings time is observed is stored even when a region where daylight savings time is not observed is selected, the user can operate the manual operation unit 40 to set the daylight savings time non-display mode and thus can prevent daylight savings time from being displayed.

Even if a region which the user wants to select is not stored as the local time setting data 541, the time can be easily corrected. For example, when setting the time of Brisbane, Australia, the user selects the time difference of +10 hours. Although daylight savings time is not observed in Brisbane, the local time setting data 541 associates the daylight savings time observation rule for Sydney with the time difference of +10 hours and therefore it is shown that information that indicates that it is a region where daylight savings time is observed is stored. Therefore, the user can set the correct time of Brisbane by operating the manual operation unit 40 to set the daylight savings time non-display mode and not to display daylight savings time.

Also, the user can grasp which display mode is set, of the daylight savings time automatic display mode and the daylight savings time non-display mode, and therefore can easily select a display mode.

### Fourth Embodiment

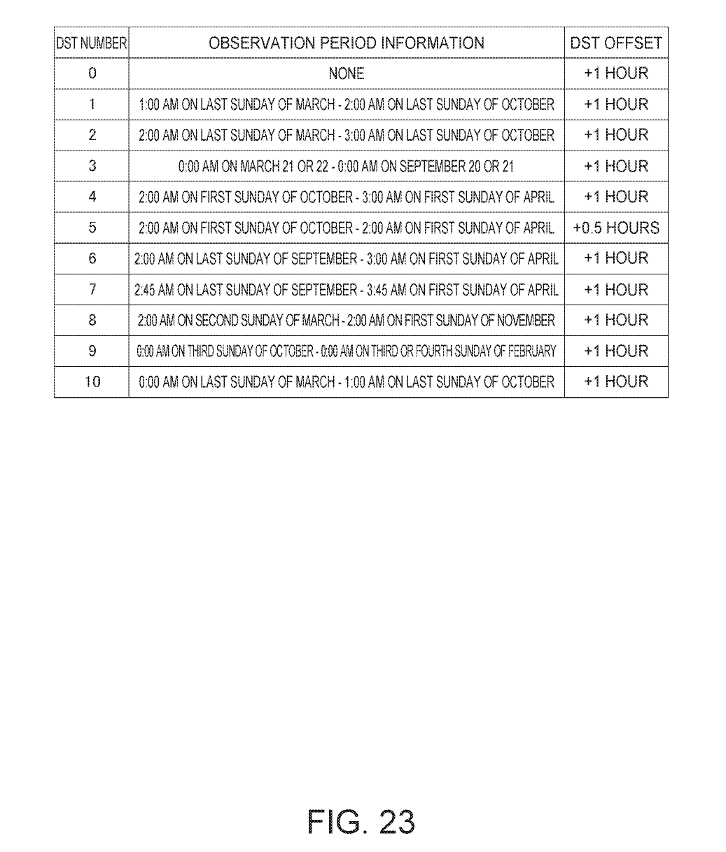

The electronic timepiece according to a fourth embodiment is configured of the electronic timepiece of the third embodiment in which the mode setting unit 69 sets a daylight savings time display mode in which daylight savings time is constantly displayed, in addition to the daylight savings time automatic display mode and the daylight savings time non-display mode. In the fourth embodiment, the daylight savings time reference data 542 shown in FIG. 23 is stored instead of the daylight savings time reference data 542 shown in FIG. 6 of the first embodiment. In the daylight savings time reference data 542 shown in FIG. 23, +1 hour is stored as the DST offset corresponding to the DST number “0”.

As shown in FIG. 20, for example, in Turkey, daylight savings time began to be observed throughout the year in 2016. That is, the time according to daylight savings time has been employed as standard time and daylight savings time has been abolished. Therefore, if the data stored in the electronic timepiece is of the 2015 version, the time one hour behind (the time not according to daylight savings time) is displayed in Turkey during a period that does not correspond to the observation period of daylight savings time observed until 2015.

Thus, the electronic timepiece of this embodiment is configured to be able to set the daylight savings time display mode, in which daylight savings time is constantly displayed.

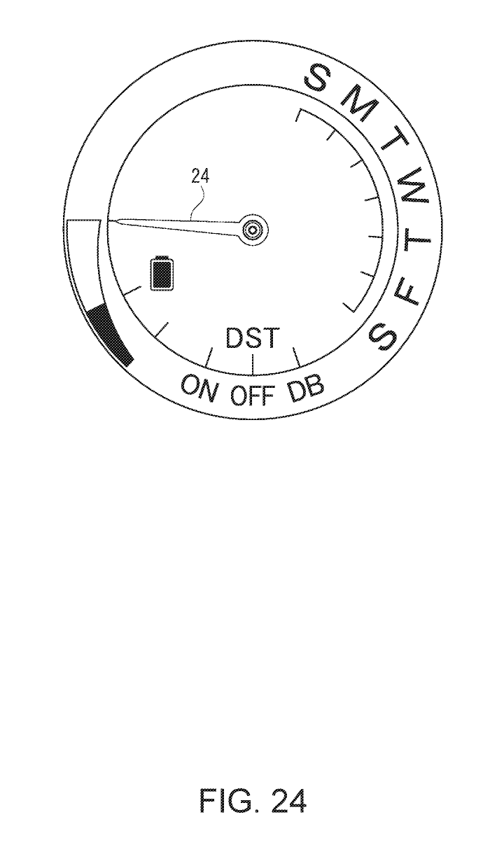

In the electronic timepiece of this embodiment, the alphabet letters “ON” are given along with the alphabet letters “DB” and “OFF” on the outer circumference of the rotation area of the hand 24, as shown in FIG. 24. The hand 24 points at ON to show that the daylight savings time display mode is set.

### Display Mode Switching Processing

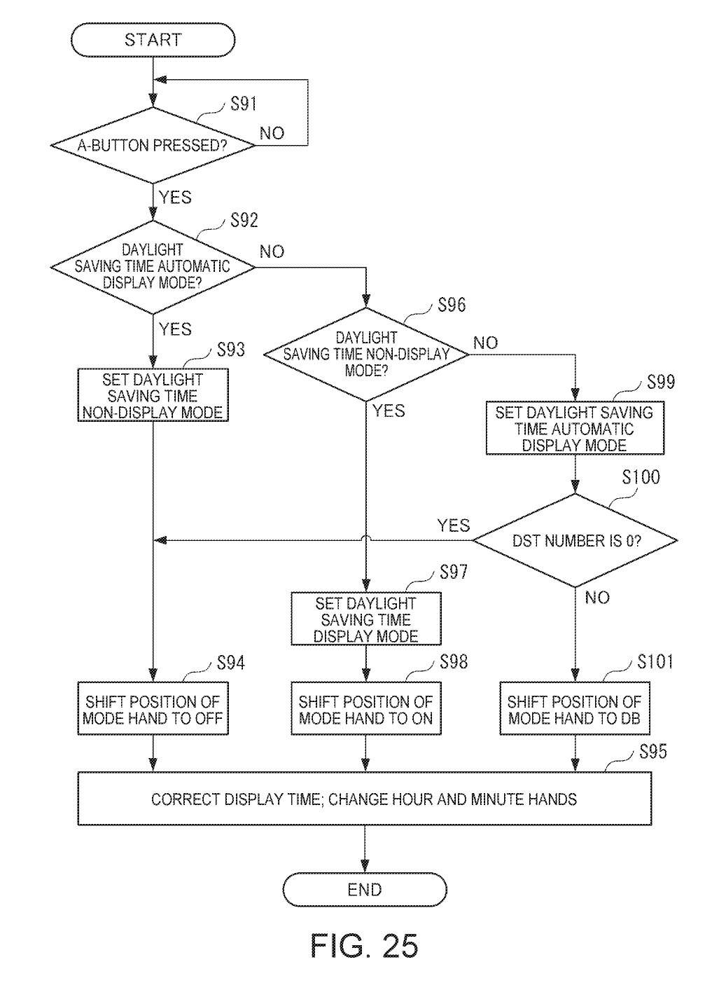

FIG. 25 is a flowchart showing display mode switching processing executed by the electronic timepiece of this embodiment.

As the display mode switching processing is executed, the mode setting unit 69 determines whether the A-button 41 is pressed or not (S91).

If the result of the determination in step S91 is YES, the mode setting unit 69 determines whether the currently set display mode is the daylight savings time automatic display mode or not (S92).

If the result of the determination in step S92 is YES, the mode setting unit 69 sets the daylight savings time non-display mode (S93).

The display control unit 63 causes the hand 24 to point at “OFF”, thus showing that the daylight savings time non-display mode is set (S94).

The time correction unit 62 initializes the daylight savings time offset data 534 and thus corrects the display time (S95). The display control unit 63 then causes the hands 22, 23 to show the hour and minute of the display time. The control circuit then returns the processing to step S91.

Meanwhile, if the result of the determination in step S92 is NO, the mode setting unit 69 determines whether the currently set display mode is the daylight savings time non-display mode or not (S96).

If the result of the determination in step S96 is YES, the mode setting unit 69 sets the daylight savings time display mode (S97).

The display control unit 63 causes the hand 24 to point at “ON”, thus showing that the daylight savings time display mode is set (S98).

In step S95, the time correction unit 62 sets the daylight savings time setting information corresponding to the selected region information as the daylight savings time offset data 534 and thus corrects the display time. The display control unit 63 then causes the hands 22, 23 to show the hour and minute of the display time. The control circuit then returns the processing to step S91.

If the result of the determination in step S96 is NO, the mode setting unit 69 sets the daylight savings time automatic display mode (S99). Thus, the daylight savings time switching processing shown in FIG. 10 is executed.

Next, the time correction unit 62 determines whether the DST number corresponding to the selected region information is 0 or not (S100).

If the result of the determination in step S100 is YES, the display control unit 63 in step S94 causes the hand 24 to point at “OFF”, thus showing that the daylight savings time automatic display mode is set and that information that indicates that it is a region where daylight savings time is observed is not stored in the storage device 54, based on the daylight savings time observation rule corresponding to the selected region information. That is, displaying “OFF” means that “the daylight savings time non-display mode is set” or that “the daylight savings time automatic display mode is set and that information that indicates that it is a region where daylight savings time is observed is not stored in the storage device 54, based on the daylight savings time observation rule corresponding to the selected region information”.

Then, in step S95, the time correction unit 62 sets hours as the daylight savings time offset data 534 (initializes the daylight savings time offset data 534) and thus corrects the display time. The display control unit 63 then causes the hands 22, 23 to show the hour and minute of the display time. The control circuit then returns the processing to step S91.

Meanwhile, if the result of the determination in step S100 is NO, the display control unit 63 causes the hand 24 to point at “DB”, showing that the daylight savings time automatic display mode is set and that information that indicates that it is a region where daylight savings time is observed is stored in the storage device 54, based on the daylight savings time observation rule corresponding to the selected region information (S101).

Then, in step S95, if daylight savings time is not currently observed, the time correction unit 62 sets 0 hours as the daylight savings time offset data 534 (initializes the daylight savings time offset data 534) and thus corrects the display time. If daylight savings time is currently observed, the time correction unit 62 sets the daylight savings time setting information of the daylight savings time reference data 542 corresponding to the selected region information as the daylight savings time offset data 534 and thus corrects the display time.

The display control unit 63 causes the hands 22, 23 to show the hour and minute of the display time. The control circuit then returns the processing to step S91.

### Advantageous Effects of Fourth Embodiment

The fourth embodiment can achieve the same advantageous effects as the third embodiment, with the same configuration as the third embodiment. The fourth embodiment can also achieve the following advantageous effects.

That is, for example, if it is shown that information that indicates that it is a region where daylight savings time is observed is not stored (the hand 24 points at “OFF”) even when a region where daylight savings time is observed is selected, the user can operate the manual operation unit 40 to set the daylight savings time display mode during the daylight savings time observation period, and thus can cause daylight savings time to be displayed.

The user can grasp which display mode is set, of the daylight savings time automatic display mode, the daylight savings time display mode, and the daylight savings time non-display mode. Therefore, the user can easily select a display mode.

In this embodiment, +1 hour is stored as the DST offset corresponding to the DST number “0” of the daylight savings time reference data 542 shown in FIG. 23. However, such information may be stored as daylight savings time setting information in another storage area, instead of being stored as the daylight savings time reference data 542.

### Fifth Embodiment

The electronic timepiece according to a fifth embodiment is configured of the electronic timepiece according to one of the first to fourth embodiments having a radio wave receiving unit which receives standard radio waves, as an additional component. In the description below, an example in which a radio wave receiving unit is added to the electronic timepiece 1 of the first embodiment will is described. The same components as those of the electronic timepiece 1 are denoted by the same reference signs and are not described further in detail.

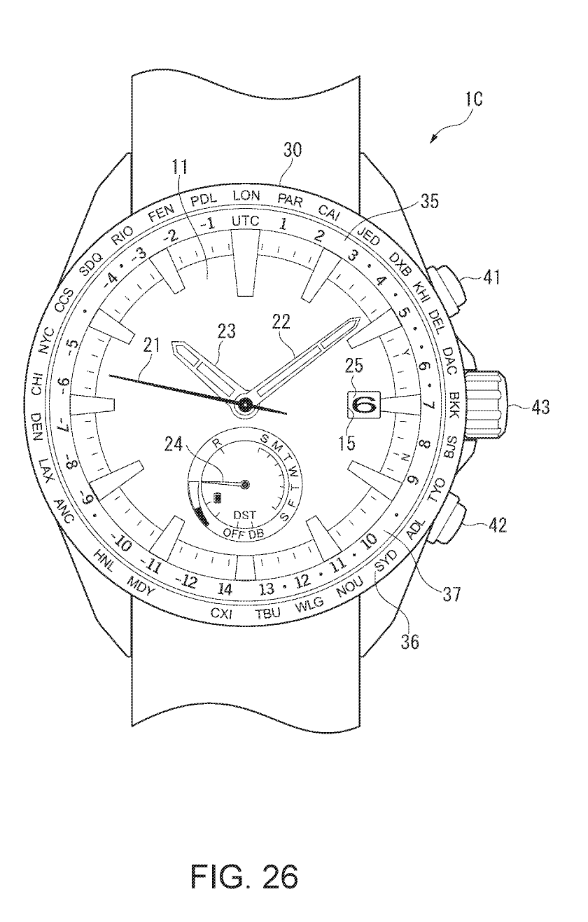

In an electronic timepiece 1C, the alphabet letter “R” is given on the outer circumference of the rotation area of the hand 24, as shown in FIG. 26. The hand 24 points at R, thus showing that standard radio waves are being received.

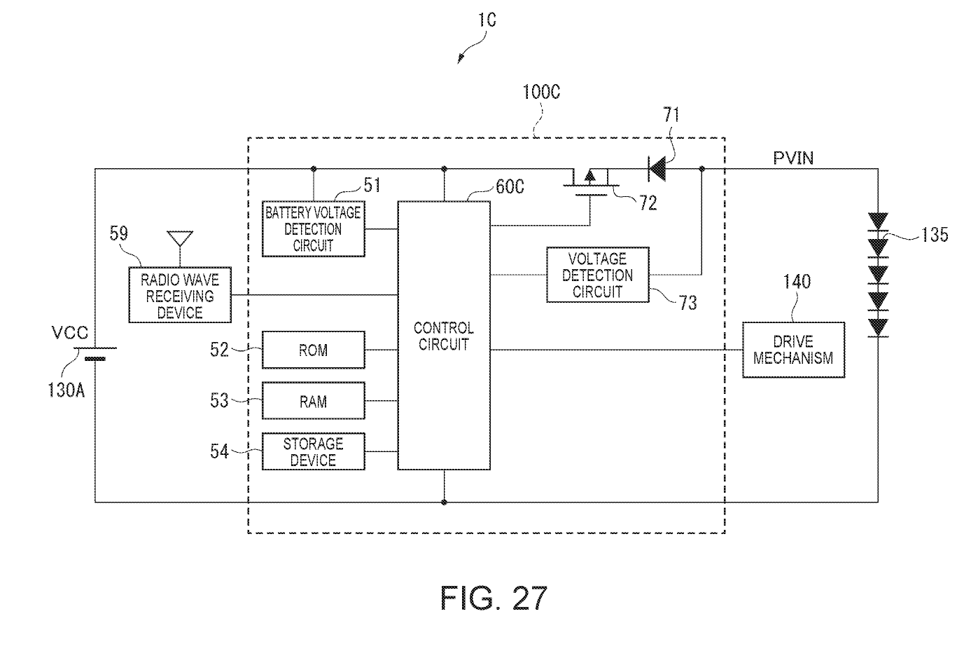

FIG. 27 shows the circuit configuration of the electronic timepiece 1C.

The electronic timepiece 1C includes a secondary battery 130A connected to a control device 100C, a solar battery 135, and a radio wave receiving device 59. The control device 100C has a diode 71, a charging control switch 72, and a voltage detection circuit 73.

The radio wave receiving device 59 as the radio wave receiving unit is a typical receiving device having a tuning circuit, an amplifier circuit, a band-pass filter, an envelope detector circuit, an AGC (auto gain control) circuit, a binarizing circuit or the like, though not illustrated.

The radio wave receiving device 59 is configured to be able to receive a plurality of standard radio waves. In this embodiment, the radio wave receiving device 59 is configured to be able to receive the Japanese standard radio wave “JJY”, the US standard radio wave “WWVB”, the German standard radio wave “DCF77”, and the British standard radio wave “MSF”.

Here, each standard radio wave includes time information and observation status information representing whether daylight savings time is currently observed or not. The radio wave receiving device 59 receives a standard radio wave, acquires the time information and the observation status information, and outputs the time information and the observation status information to a control circuit 60C.

In this embodiment, the time correction unit 62 updates the internal time data 531 with the time information acquired by receiving the standard radio wave and thus corrects the internal time.

The observation determination unit 66 determines whether daylight savings time is currently observed or not, based on the acquired observation status information.

### Standard Radio Wave Reception Processing

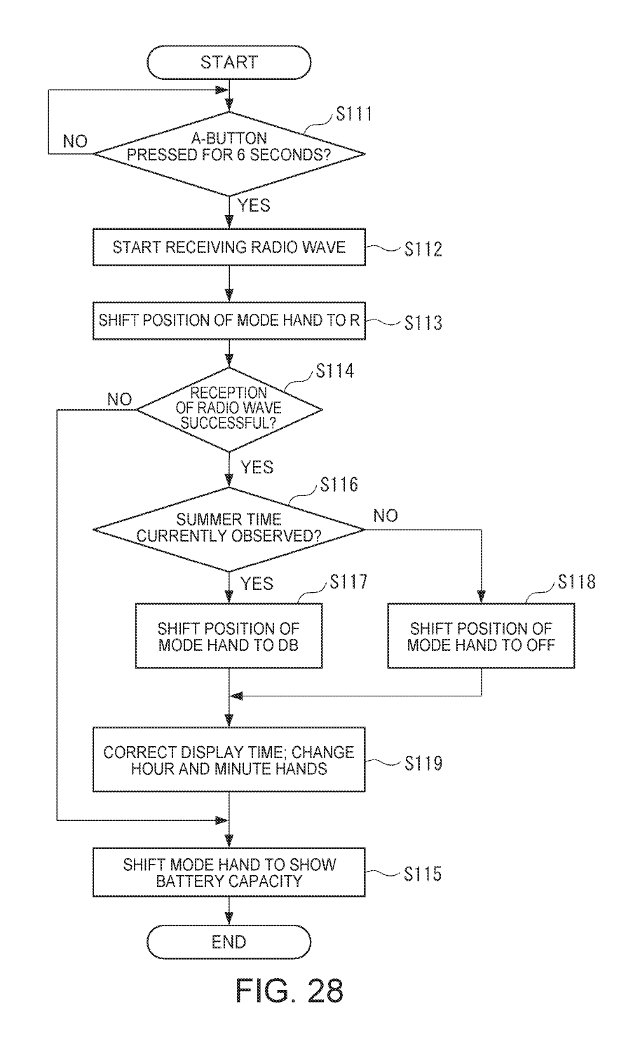

FIG. 28 is a flowchart showing standard radio wave reception processing executed by the electronic timepiece 1C.

The control circuit 60C determines whether the A-button 41 is pressed for 6 seconds or not (S111). If the result of the determination in step S111 is NO, the control circuit 60C repeats the execution of the processing of step 5111.

If the result of the determination in step S111 is YES, the control circuit 60C actuates the radio wave receiving device 59 to start reception processing (S112).

The display control unit 63 causes the hand 24 to point at “R”, thus showing that a standard radio wave is being received (S113).

Next, the control circuit 60C determines whether the reception is successful or not, that is, whether time information and observation status information are acquired or not (S114).

If the result of the determination in step S114 is NO, the display control unit 63 causes the hand 24 to show the battery capacity (S115). The control circuit 60C then ends the standard radio wave reception processing.

Meanwhile, if the result of the determination in step S114 is YES, the observation determination unit 66 determines whether daylight savings time is currently observed or not, based on the acquired observation status information (S116).

If the result of the determination in step S116 is YES, the display control unit 63 causes the hand 24 to point at “DB”, thus showing that daylight savings time is currently observed (S117).

Meanwhile, if the result of the determination in step S116 is NO, the display control unit 63 causes the hand 24 to point at “OFF”, thus showing that daylight savings time is not currently observed (S118).

After the processing of step S117 or S118, the time correction unit 62 updates the internal time data 531, based on the acquired time information, and thus corrects the internal time. Specifically, the time correction unit 62 subtracts a set time difference from the time represented by the acquired time information, thus calculates UTC, and updates the internal time data 531 with the resulting UTC. The time correction unit 62 thus corrects the display time (S119). The display control unit 63 then causes the hands 21, 22, 23 to show the hour, minute and second of the display time.

Subsequently, in step S115, the display control unit 63 causes the hand 24 to show the battery capacity. The control circuit 60C then ends the standard radio wave reception processing.

The reception processing may also be executed at preset time.

### Advantageous Effects of Fifth Embodiment

The fifth embodiment can achieve the same advantageous effects as the first to fourth embodiments, with the same configuration as the first to fourth embodiments. The fifth embodiment can also achieve the following advantageous effects.

That is, the standard radio wave reception processing is executed. This allows the user to grasp whether daylight savings time is currently observed or not.

Also, whether daylight savings time is currently observed or not can be determined based on the observation status information. Therefore, there is no need to determine, for example, whether the current time falls within the daylight savings time observation period or not. This enables easy determination of whether daylight savings time is currently observed or not.

### Sixth Embodiment

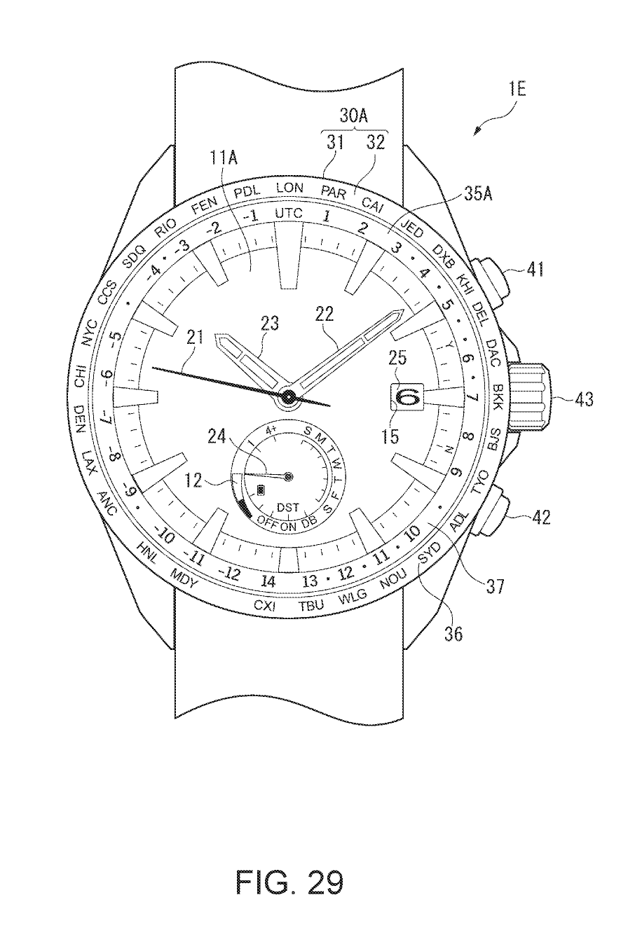

An electronic timepiece 1E according to a sixth embodiment will be described with reference to FIGS. 29 to 33. The electronic timepiece 1E has a configuration similar to that of the electronic timepiece 1A of the second embodiment and is different from the electronic timepiece 1A in that the daylight savings time display mode and the daylight savings time non-display mode can be selected by manual operation. Therefore, in FIGS. 29 to 33, the same components as those of the electronic timepiece 1A are denoted by the same reference signs and are not described further in detail.

The electronic timepiece 1E is configured in such a way that the hand 24 can point at the three pieces of information “DB”, “OFF”, and “ON” about daylight savings time (DST) in addition to information showing the calendar (day of the week), a symbol 12 indicating the remaining battery capacity, and information indicating the reception mode, as shown in FIG. 29.

The hand 24 points at “DB” when the daylight savings time automatic display mode is set, as in the second embodiment. The hand 24 points at “ON” when the user selects the daylight savings time display mode by manual operation. The hand 24 points at “OFF” when the user selects the daylight savings time non-display mode by manual operation.

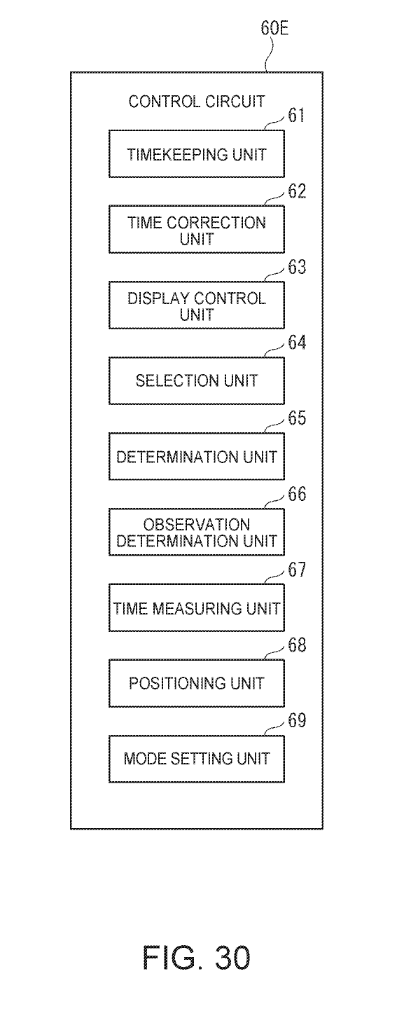

The electronic timepiece 1E has a control circuit 60E as shown in FIG. 30. The control circuit 60E has a timekeeping unit 61(timekeeper), a time correction unit 62 (time corrector), a display control unit 63 (display controller), a selection unit 64 (selector), a determination unit 65 (determiner), an observation determination unit 66 (observation determiner), a time measuring unit 67 (tie measurer), a positioning unit 68 (positioner), and a mode setting unit 69 (mode setter). The components from the timekeeping unit 61 to the positioning unit 68 are the same as in the control circuit 60A of the second embodiment. The mode setting unit 69 sets one of the daylight savings time display mode and the daylight savings time non-display mode in response to an operation on the manual operation unit 40, as in the third embodiment. The mode setting unit 69 also sets one of the daylight savings time automatic display mode and the daylight savings time non-display mode according to the daylight savings time observation rule (DST number) for the area of the current location by positioning reception processing.

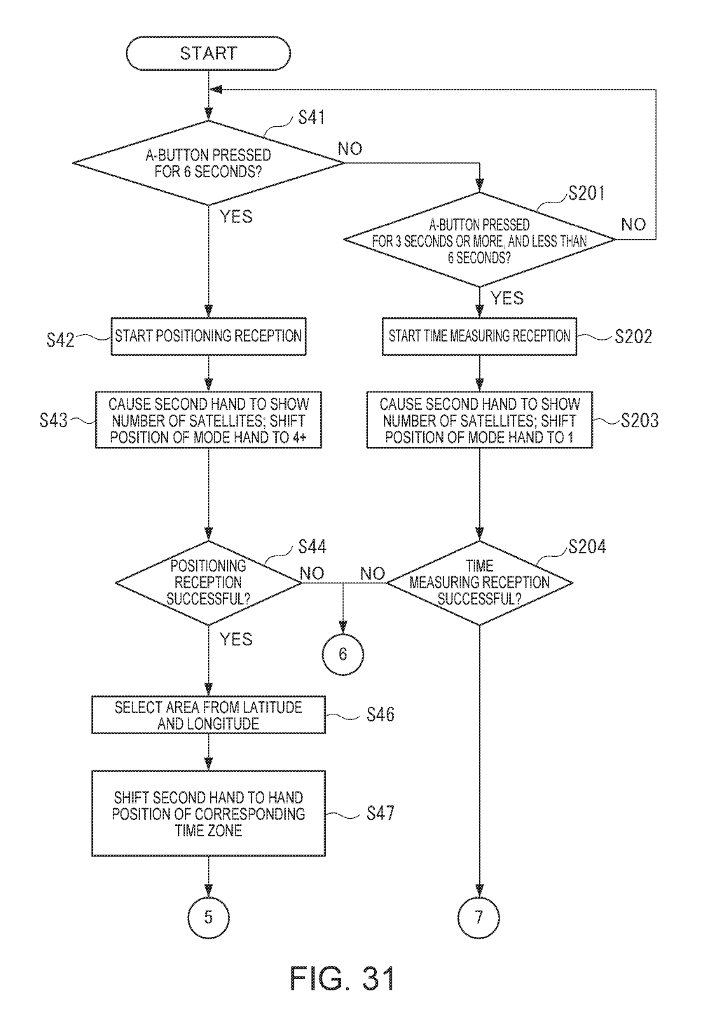

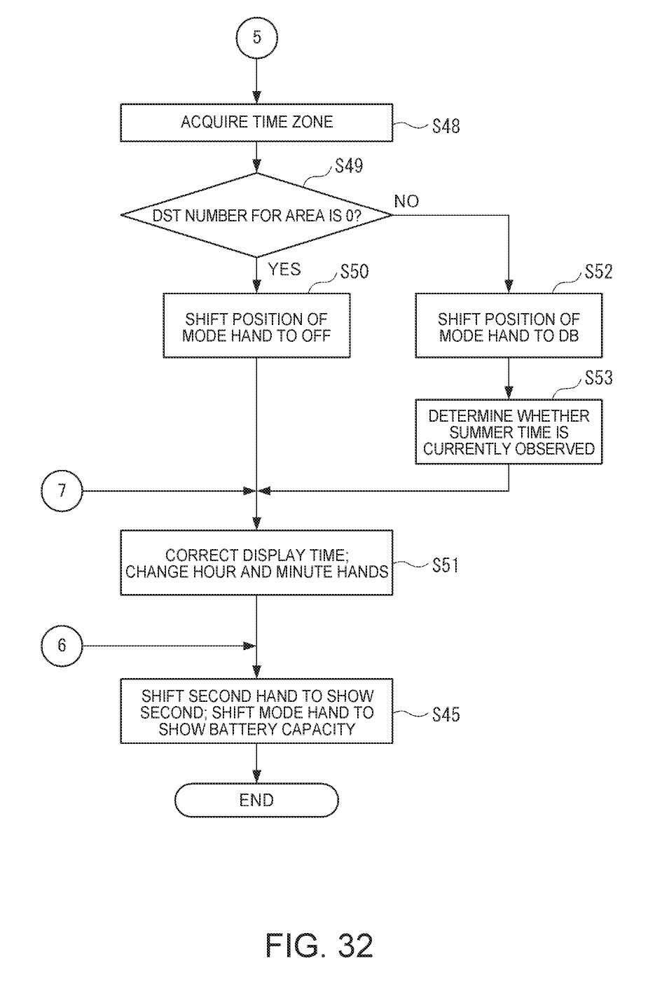

Next, the reception processing by the electronic timepiece 1E will be described with reference to FIGS. 31 and 32. In FIGS. 31 and 32, the same processing steps as in FIGS. 18 and 19 of the second embodiment are denoted by the same reference signs and are not described further in detail.

The control circuit 60E of the electronic timepiece 1E determines whether the A-button 41 is pressed for 6 seconds or not (S41). If the result of the determination in step S41 is YES, the positioning unit 68 is actuated. The positioning unit 68 executes steps S42 to S44, as in the second embodiment. If the position reception is successful (YES in step S44), the control circuit 60E executes steps S46 and S47 and also executes the processing in FIG. 32. If the positioning reception fails (NO in step S44), the control circuit 60E executed step S45 in FIG. 32, as in the second embodiment. If the result of the determination by the determination unit 65 in step S49 is YES, the mode setting unit 69 sets the daylight savings time non-display mode (OFF). If the result of the determination in step S49 is NO, the mode setting unit 69 sets the daylight savings time automatic display mode (DB).

If the result of the determination in step S41 is NO, the control circuit 60E of the electronic timepiece 1E determines whether the A-button 41 is pressed for 3 seconds or more, and less than 6 seconds (S201). If the result of the determination in step S201 is YES, the time measuring unit 67 is actuated. The time measuring unit 67 executes steps S202 to S204. That is, the time measuring unit 67 actuates the GPS receiving device 58 to start the reception processing in the time measuring mode (S202).

The display control unit 63 causes the hand 21 to show the number of GPS satellites that are captured (number of captured satellites) (S203), as in step S43 in the positioning mode. Also, in step S203, the display control unit 63 causes the hand 24 to point at “1”, thus showing that the reception mode is the time measuring mode.

Next, the time measuring unit 67 determines whether the positioning reception is successful or not, that is, whether the acquisition of time information (UTC) is successful or not (S204).

If the result of the determination in step S204 is NO, the display control unit 63 causes the hand 21 to show the second of the display time and causes the hand 24 to show the battery capacity (S45). The control circuit 60E then ends the reception processing.

Meanwhile, if the result of the determination in step S204 is YES, the time correction unit 62 corrects the display time of the display time data 532, using the currently set time difference (time zone) and the information of daylight savings time (S51). The display control unit 63 then causes the hands 22, 23 to show the hour and minute of the display time. Thus, the time reflecting the time difference corresponding to the currently selected area information is displayed.

After the processing of step S51, the display control unit 63 in step S45 causes the hand 21, previously pointing at the number of captured satellites, to show the second of the display time, and causes the hand 24 to show the battery capacity. The control circuit 60E then ends the reception processing.

Since the area (time zone) is not changed at the time of time measuring reception, the hand 24 does not point at the information of daylight savings time in this embodiment. However, the hand 24 may point at the daylight savings time information (one of DB, ON, and OFF) for a predetermined period before showing the battery capacity in step S45, as in the positioning reception processing.

### Display Mode Switching Processing

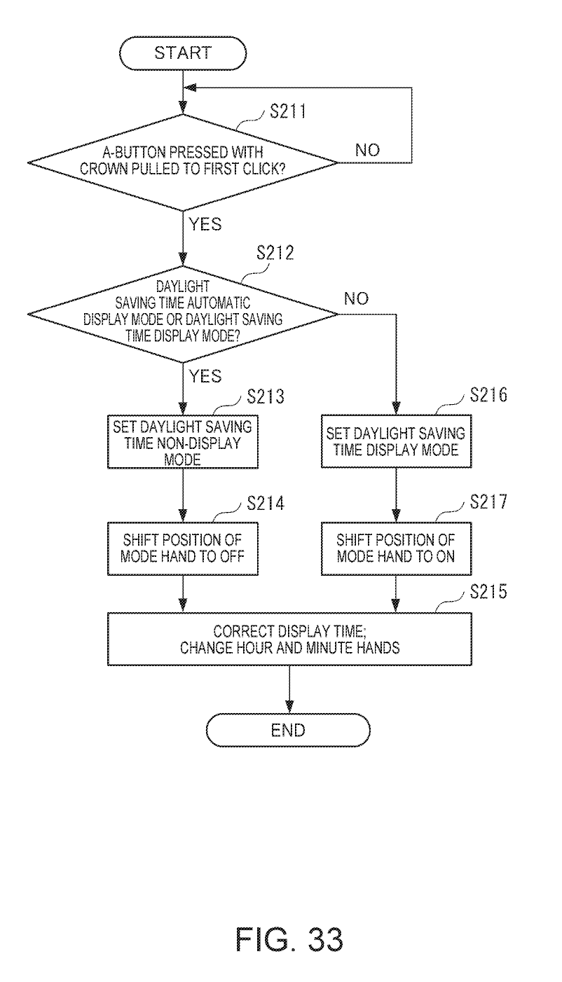

FIG. 33 is a flowchart showing display mode switching processing executed by the electronic timepiece 1E of this embodiment.

The control circuit 60E determines whether the A-button 41 is pressed with the crown 43 pulled out to the first click or not (S211). If the result of the determination in step S211 is YES, the control circuit 60E causes the mode setting unit 69 to execute the display mode switching processing.

If the result of the determination in step S211 is YES, the mode setting unit 69 determines whether the current set display mode is the daylight savings time automatic display mode or the daylight savings time display mode, or not (S212).

If the result of the determination in step S212 is YES, the mode setting unit 69 sets the daylight savings time non-display mode (S213). The display control unit 63 then causes the hand 24 to point at “OFF”, thus showing that the daylight savings time non-display mode is set (S214).

The time correction unit 62 initializes the daylight savings time offset data 534 and thus corrects the display time (S215). The display control unit 63 causes the hands 22, 23 to show the hour and minute of the display time. The control circuit 60E then returns the processing to step S211.

Meanwhile, if the result of the determination in step S212 is NO, the mode setting unit 69 sets the daylight savings time display mode (S216). The display control unit 63 then causes the hand 24 to point at “ON”, thus showing that the daylight savings time display mode is set (S217).

The time correction unit 62 sets the daylight savings time setting information corresponding to the selected region information as the daylight savings time offset data 534 and thus corrects the display time (S215). The display control unit 63 causes the hands 22, 23 to show the hour and minute of the display time. The control circuit 60E then returns the processing to step S211.

The display mode switching processing ends when the crown 43 is shifted from the first-click position to the 0-position or the second-click position.

Thus, in the electronic timepiece 1E, when positioning reception processing is carried out, the time zone and the DST number indicating the type of daylight savings time observation rule are acquired from the acquired location information (area). If a daylight savings time observation rule is set for the area, that is, if the DST number is not “0”, the daylight savings time automatic display mode (DB) is set. If no daylight savings time observation rule is set for the area, that is, if the DST number is “0”, the daylight savings time non-display mode (OFF) is set.

If the user pulls out the crown 43 to the first-click position and presses the A-button 41 to execute the display mode switching processing, the mode setting unit 69 selects alternately selects the daylight savings time display mode (ON) and the daylight savings time non-display mode (OFF) every time the A-button 41 is pressed. Therefore, the user can manually set whether to display daylight savings time or not, in cases such as where the daylight savings time observation rule is changed but the local time reception setting data 546 is not updated. When the daylight savings time display mode (ON) is set, the time correction unit 62 may normally set +1 hour as the data to be set as the daylight savings time offset data 534. However, if the DST offset of the local time setting data 541 is set to +0.5 hours for the selected area (area with the index 18 in FIG. 5), the time correction unit 62 may set +0.5 hours as the daylight savings time offset data 534. That is, when the daylight savings time display mode (ON) is manually set, a preset time for each time zone maybe set as the daylight savings time offset data 534. As the preset time, basically, +1 hour may be set, which is often used in daylight savings time. Also, +0.5 hours or the like may be set, depending on the region. Moreover, it is possible to enable the input of the daylight savings time offset data 534 by an operation of the crown 43 or the like by the user.

If the time measuring reception processing is executed after the user manually selects the daylight savings time display mode (ON), the display time is corrected based on the received time information (UTC), the time difference of the time zone, and the daylight savings time offset data 534.

If the user manually sets the daylight savings time display mode (ON) or the daylight savings time non-display mode (OFF), the manual setting is maintained until the daylight savings time automatic display mode (DB) or the daylight savings time non-display mode (OFF) is set by the positioning reception processing.

### Advantageous Effects of Sixth Embodiment

The sixth embodiment can achieve advantageous effects similar to those of the first to fourth embodiments, with configurations similar to those of the first to fourth embodiments. The sixth embodiment can also achieve the following advantageous effects.

Since the daylight savings time display mode (ON) or the daylight savings time non-display mode (OFF) can be set by user's manual operation, the user can select whether to display daylight savings time or not, as intended. Therefore, even if the local time reception setting data 546 or the like is not updated with the latest data immediately after the daylight savings time observation rule is changed, the time corresponding to the changed rule can be displayed. This can improve convenience. Also, manual operation is only available for setting the daylight savings time display mode (ON) or the daylight savings time non-display mode (OFF), and not for selecting the daylight savings time automatic display mode (DB). Therefore, the user can set the display time as intended. This can provide intelligibility and hence operability to the user.

### Other Embodiments

The invention is not limited to the foregoing embodiments and includes modifications, improvements and the like within a scope where the object of the invention can be achieved.

In the local time setting processing and the local time reception setting processing in the embodiments, if information that indicates that it is a region where daylight savings time is observed is stored in the storage device 54, based on the daylight savings time observation rule corresponding to the selected region information, the display control unit 63 causes the hand 24 to point at “DB”, thus showing that information that indicates that it is a region where daylight savings time is observed is stored in the storage device 54. However, the invention is not limited to this. For example, the display control unit 63 may cause the hand 24 to show whether daylight savings time is currently observed or not, in addition to that information that indicates that it is a region where daylight savings time is observed is stored in the storage device 54.

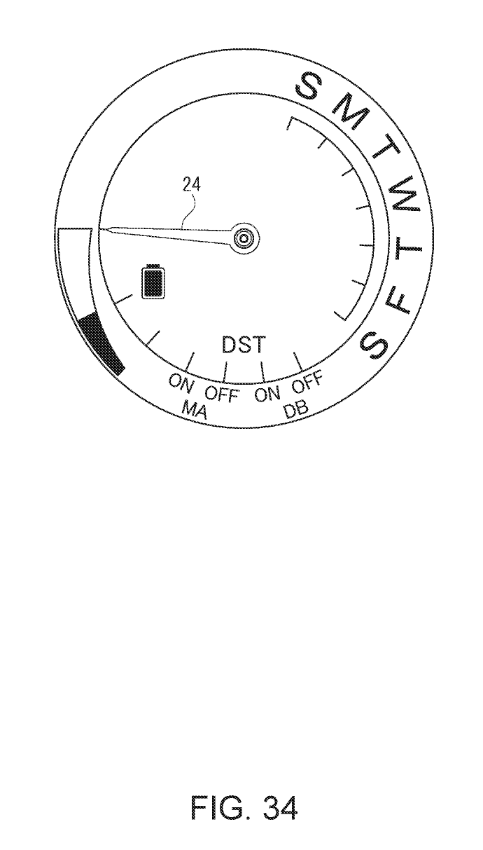

In this case, the alphabet letters “DB” and the alphabet letters “ON” and “OFF” situated on the inner side of the alphabet letters “DB” are given on the outer circumference of the rotation area of the hand 24 on the dial of the electronic timepiece, for example, as shown in FIG. 34. The hand 24 points at “ON” to show that information that indicates that it is a region where daylight savings time is observed is stored in the storage device 54 and that daylight savings time is currently observed. Meanwhile, the hand 24 points at “OFF” to show that information that indicates that it is a region where daylight savings time is observed is stored in the storage device 54 and that daylight savings time is not currently observed.

In this example, the alphabet letters “MA” and the alphabet letters “ON” and “OFF” situated on the inner side of the alphabet letters “MA” are also given on the outer circumference of the rotation area of the hand 24. The hand 24 points at “ON” to show that the daylight savings time display mode is set, and points at “OFF” to show that the daylight savings time non-display mode is set. Also, the hand 24 points at “ON” or “OFF” on the inner side of “DB” to show that the daylight savings time automatic display mode is set.

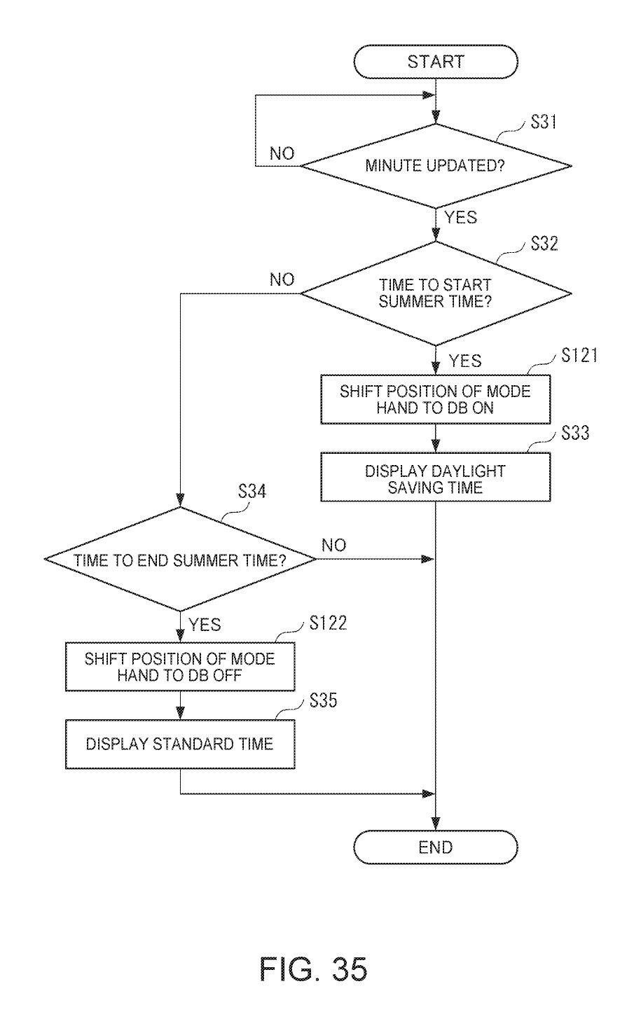

The daylight savings time switching processing in this modification example, as shown in FIG. 35, if it is determined in step S32 that it is time to start daylight savings time (the result of the determination in step S32 is YES), the display control unit 63 causes the hand 24 to point at “ON” on the inner side of “DB”, thus showing that daylight savings time is currently observed (S121).

Meanwhile, if it is determined in step S34 that it is time to end daylight savings time (the result of the determination in step S34 is YES), the display control unit 63 causes the hand 24 to point at “OFF” on the inner side of “DB”, thus showing that daylight savings time is not currently observed (S122).

In the embodiments, the hand 24 shows whether information that indicates that it is a region where daylight savings time is observed is stored in the storage device 54 or not, whether daylight savings time is currently observed or not, and which display mode is employed or the like. However, the invention is not limited to this. For example, the hand 21 may show such information.

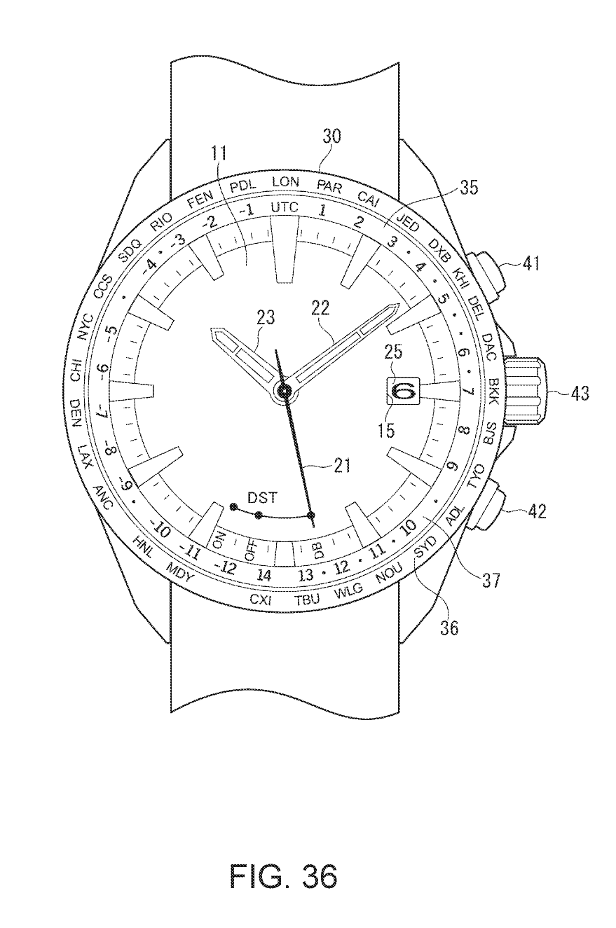

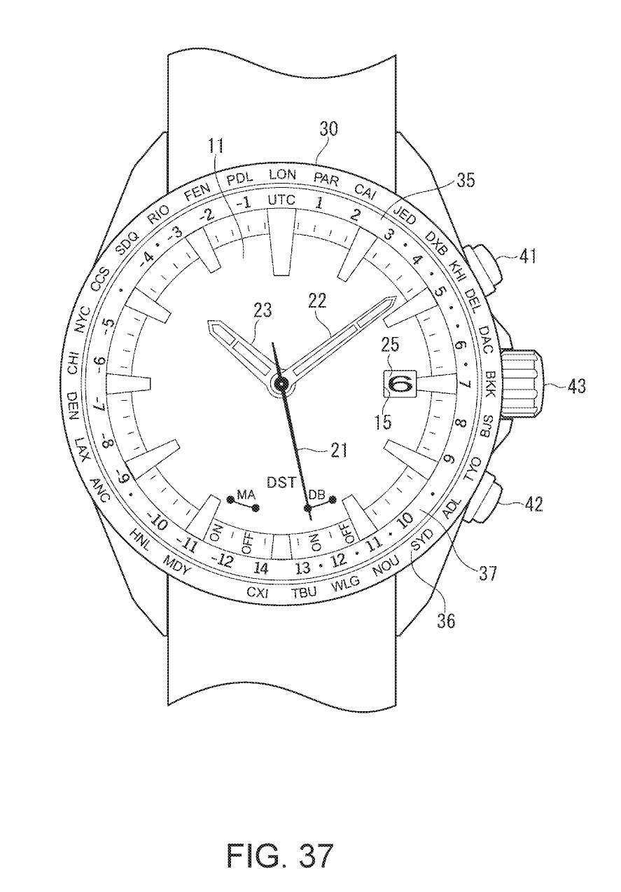

For example, in the display mechanism of the electronic timepiece of the fourth embodiment, the alphabet letters “DB”, “OFF”, and “ON” may be given on the dial ring 35, and the hand 21 may point at these alphabet letters, as shown in FIG. 36. Also, in the display mechanism of the electronic timepiece in the modification example, the alphabet letters “DB” and “MA” may be given on the dial 11, and the alphabet letters “OFF” and “ON” may be given on the dial ring 35, near “DB” and “MA”, as shown in FIG. 37. The hand 21 may point at these alphabet letters.

Moreover, the daylight savings time information such as “DB”, “OFF”, and “ON”, which the hand 24 points at in the embodiments, may be shown by the calendar wheel 25 such as a date wheel or days of the week wheel, or may be shown by a different display wheel that is prepared separately from the calendar wheel 25. For example, the sixth embodiment shown in FIG. 29 is configured in such a way that the hand 24 points at one of “DB”, “OFF”, and “ON”, as the currently set daylight savings time information. Thus, “DB”, “OFF”, and “ON” may be given by printing on the calendar wheel 25, and in steps S50, S52 in FIG. 32 and steps S214, S217 in FIG. 33, the calendar wheel 25 may be moved to show one of “DB”, “OFF”, and “ON”. Alternatively, a dedicated display wheel showing “DB”, “OFF”, and “ON” may be prepared. Also, “DB”, “OFF”, “ON” or the like may be given on an information display wheel which shows information other than calendar, and the information display wheel may also be used to show the daylight savings time information. The display wheel which shows information other than calendar is, for example, a display wheel which shows city information indicating the time zone, or a display wheel which shows information such as temperature, altitude, and direction measured by a sensor provided in the electronic timepiece or the like.

In the second embodiment, the local time reception setting data 546 is stored in the storage device 54 provided in the control device 100A. However, the invention is not limited to this. For example, the local time reception setting data 546 may be stored in a storage device provided in the GPS receiving device 58 or in a storage device externally attached to the GPS receiving device 58. In this case, the GPS receiving device 58 selects area information, based on the acquired location information, and outputs the time difference, DST number, and daylight savings time information corresponding to the selected area information, to control circuit 60A.

In the embodiments, the daylight savings time setting information corresponding to the region information is stored as the daylight savings time reference data 542. However, the invention is not limited to this. For example, daylight savings time setting information (for example, +1 hour) common to each piece of region information may be stored in the storage device 54. In the case of correcting the display time with the daylight savings time setting information, the daylight savings time setting information need not be stored in association with the region information as the daylight savings time reference data 542, no matter which region information is selected.

In the embodiments, the information display unit and the time display unit are configured of the hands and the dial. However, the invention is not limited to this. For example, these units may be configured of a digital display device such as a liquid crystal display device. In this case, the hand positions need not be stored as the local time setting data 541.

In the second embodiment, GPS satellites are described as an example of the location information satellites. However, the invention is not limited to this. For example, satellites used in other global navigation satellite systems (GNSS) such as Galileo (EU), GLONASS (Russia), and BeiDou (china), can be employed as the location information satellites. Also, geostationary satellites of a satellite-based augmentation system (SBAS) or the like, or satellites of a regional navigation satellite system (RNSS) or the like that enable search in a specific region only, such as quasi-zenith satellites can be employed.

In the embodiments, the daylight savings time observation rule includes the DST number of the local time setting data 541, and the DST number, the daylight savings time observation period, and the daylight savings time setting information of the daylight savings time reference data 542. However, the invention is not limited to this. For example, as the local time setting data 541, the daylight savings time observation period and the daylight savings time setting information may be stored in association with the region information. In this case, it may be determined that it is a region where daylight savings time is observed, if the daylight savings time observation period and the daylight savings time setting information are included in association with the region information. It may be determined that it is not a region where daylight savings time is observed, if the daylight savings time observation period and the daylight savings time setting information are not included in association with the region information.

The entire disclosures of Japanese Patent Application Nos. 2017-048891 filed Mar. 14, 2017 and 2017-245502 filed Dec. 21, 2017 are expressly incorporated by reference.

What is claimed is:

1. An electronic timepiece comprising:
an information display;
a memory configured to store a plurality of pieces of region information and a daylight savings time observation rule corresponding to the region information;
a selector configured to select one of the plurality of pieces of region information stored in the memory;
a determiner configured to determine whether the one piece of region information identifies a region where daylight savings time is observed or not, based on the daylight savings time observation rule corresponding to the one piece of region information selected by the selector; and
a display controller configured to cause the information display to display that daylight savings time is observed, if it is determined that daylight savings time is observed in the region.

2. The electronic timepiece according to claim 1, further comprising:
a satellite signal receiver configured to receive a satellite signal and obtain location information of a current location based on the satellite signal,
wherein the selector is configured to select region information to which the current location belongs from the plurality of pieces of region information as the one piece of region information, based on the location information.

3. The electronic timepiece according to claim 1, further comprising:
a manual operation unit,
wherein the selector is configured to select the one piece of region information in response to an operation of the manual operation unit.

4. The electronic timepiece according to claim 1, further comprising:
a radio wave receiver configured to receive radio waves including observation status information indicating whether daylight savings time is currently observed or not; and
an observation determiner configured to determine whether daylight savings time is currently observed or not, based on the observation status information,
wherein the display controller causes the information display to display that daylight savings time is currently observed, if it is determined that daylight savings time is currently observed by the observation determiner.

5. The electronic timepiece according to claim 1, wherein
the daylight savings time observation rule includes observation period information indicating a daylight savings time observation period,
the electronic timepiece further comprises an observation determiner configured to determine whether daylight savings time is currently observed or not, based on the observation period information corresponding to the one piece of region information selected by the selector, and
the display controller causes the information display to display that daylight savings time is currently observed, if it is determined that daylight savings time is currently observed by the observation determiner.

6. The electronic timepiece according to claim 1, further comprising:
a time display which is controlled by the display controller and displays time information;
a time corrector configured to correct the time information; and
an observation determiner configured to determine whether daylight savings time is currently observed or not,
wherein the daylight savings time observation rule includes daylight savings time setting information about a time difference between standard time and daylight savings time according to the region information, and
the time corrector corrects the time information based on the daylight savings time setting information if it is determined that daylight savings time is currently observed by the observation determiner.

7. The electronic timepiece according to claim 6, further comprising:
a manual operation unit; and
a mode setter configured to set one of a daylight savings time automatic display mode and a daylight savings time non-display mode in response to an operation of the manual operation unit,
wherein the time corrector is configured to:
correct the time information and cause daylight savings time to be displayed, based on the daylight savings time setting information, if the daylight savings time automatic display mode is set and the observation determiner determines that daylight savings time is currently observed, and
not cause daylight savings time to be displayed, if the daylight savings time automatic display mode is set and the observation determiner determines that daylight savings time is not currently observed, or if the daylight savings time non-display mode is set.

8. An electronic timepiece comprising:
an information display;
a time display configured to display time information;
a time corrector configured to correct the time information;
a display controller configured to control the information display;
a memory configured to store a plurality of pieces of region information and a daylight savings time observation rule, the daylight savings time observation rule including observation period information corresponding to the region information and indicating a daylight savings time observation period and daylight savings time setting information corresponding to the region information and indicating a time difference from standard time;
a selector configured to select one of the plurality of pieces of region information stored in the memory;
a determiner configured to determine whether the one piece of region information identifies a region where daylight savings time is observed or not, based on the daylight savings time observation rule corresponding to the one piece of region information selected by the selector;
an observation determiner configured to determine whether daylight savings time is currently observed or not, based on the observation period information; and
a mode setter configured to set one of a daylight savings time automatic display mode, a daylight savings time display mode, and a daylight savings time non-display mode in response to an operation of a manual operation unit,
wherein the display controller is configured to:
cause the information display to display that daylight savings time is observed, if the daylight savings time automatic display mode is set and the determiner determines that daylight savings time is observed, and
the time corrector is configured to:
correct the time information and cause daylight savings time to be displayed, based on the daylight savings time setting information, if the daylight savings time automatic display mode is set and it is determined that daylight savings time is currently observed, or if the daylight savings time display mode is set, and
not cause daylight savings time to be displayed, if the daylight savings time automatic display mode is set and it is determined that daylight savings time is not currently observed, or if the daylight savings time non-display mode is set.

9. The electronic timepiece according to claim 8, wherein
the display controller is configured to:
cause the information display to display that the daylight savings time display mode is set if the daylight savings time display mode is set, and
cause the information display to display that the daylight savings time non-display mode is set if the daylight savings time non-display mode is set.

10. An electronic timepiece comprising:
an information display;
a time display configured to display time information;
a time corrector configured to correct the time information;
a display controller;
a memory configured to store a plurality of pieces of region information and a daylight savings time observation rule, the daylight savings time observation rule including observation period information corresponding to the region information and indicating a daylight savings time observation period and daylight savings time setting information corresponding to the region information and indicating a time difference from standard time;
a selector configured to select one of the plurality of pieces of region information stored in the memory;
a determiner configured to determine whether the one piece of region information identifies a region where daylight savings time is observed or not, based on the daylight savings time observation rule corresponding to the one piece of region information selected by the selector;
an observation determiner configured to determine whether daylight savings time is currently observed or not, based on the observation period information; and
a mode setter configured to set one of a daylight savings time display mode and a daylight savings time non-display mode in response to an operation of a manual operation unit,
wherein the display controller is configured to:
cause the information display to display that the daylight savings time display mode is set if the daylight savings time display mode is set, and
cause the information display to display that the daylight savings time non-display mode is set if the daylight savings time non-display mode is set, and
the time corrector is configured to:
correct the time information and cause daylight savings time to be displayed, based on the daylight savings time setting information corresponding to the one piece of region information selected by the selector, if the daylight savings time display mode is set, and
cause standard time to be displayed if the daylight savings time non-display mode is set.

11. The electronic timepiece according to claim 10, further comprising:
a satellite signal receiver configured to receive a satellite signal and obtain location information of a current location based on the satellite signal,
wherein the selector is configured to select region information to which the current location belongs from the plurality of pieces of region information as the one piece of region information, based on the location information,
the mode setter is configured to:
set a daylight savings time automatic display mode if the determiner determines that the one piece of region information identifies a region where daylight savings time is observed, based on the region information selected based on the location information, and
set the daylight savings time non-display mode if the determiner determines that the one piece of region information identifies a region where daylight savings time is not observed, based on the region information selected based on the location information,
the display controller is configured to:
cause the information display to display that daylight savings time is observed, if the daylight savings time automatic display mode is set and the determiner determines that daylight savings time is observed, and
the time corrector is configured to:
correct the time information and cause daylight savings time to be displayed, based on the daylight savings time setting information, if the daylight savings time automatic display mode is set and it is determined that daylight savings time is currently observed, and
cause standard time to be displayed, if the daylight savings time automatic display mode is set and it is determined that daylight savings time is not currently observed.

12. The electronic timepiece according to claim 1, wherein
the information display is configured of hands and a dial.

13. The electronic timepiece according to claim 8, wherein
the information display is configured of hands and a dial.

14. The electronic timepiece according to claim 10, wherein
the information display is configured of hands and a dial.
